(19) United States
(12) Patent Application Publication
(10) Pub. No.: US 2018/0090744 A1
(43) Pub. Date: Mar. 29, 2018

(54) MATERIAL FOR NEGATIVE ELECTRODE, ELECTRODE SHEET FOR ALL-SOLID STATE SECONDARY BATTERY, ALL-SOLID STATE SECONDARY BATTERY, AND METHODS FOR MANUFACTURING ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Katsuhiko Meguro, Ashigarakami-gun (JP); Hiroaki Mochizuki, Ashigarakami-gun (JP); Masaomi Makino, Ashigarakami-gun (JP); Tomonori Mimura, Ashigarakami-gun (JP)

(73) Assignee: FUJIFILM Corporation, Tokyo (JP)

(21) Appl. No.: 15/828,591

(22) Filed: Dec. 1, 2017

Related U.S. Application Data
(63) Continuation of application No. PCT/JP2016/065653, filed on May 26, 2016.

(30) Foreign Application Priority Data
Jun. 2, 2015 (JP) 2015-112323

(51) Int. Cl. H01M 4/133; H01M 10/0562; H01M 4/62; H01M 4/139; H01M 10/0525

(52) U.S. Cl. CPC H01M 4/133; H01M 10/0562; H01M 10/0525; H01M 4/139; H01M 4/621

(57) ABSTRACT

A material for a negative electrode containing a carbonaceous material that is a negative electrode active material, an inorganic solid electrolyte, and a non-conductive compound having a ring structure with three or more rings, an electrode sheet for an all-solid state secondary battery and an all-solid state secondary battery for which the material for a negative electrode is used, and methods for manufacturing an electrode sheet for an all-solid state secondary battery and an all-solid state secondary battery.

### CROSS-REFERENCE TO RELATED APPLICATIONS

This application is a Continuation of PCT International Application No. PCT/JP2016/065653 filed on May 26, 2016, which claims priority under 35 U.S.C. § 119 (a) to Japanese Patent Application No. 2015-112323 filed in Japan on Jun. 2, 2015. Each of the above applications is hereby expressly incorporated by reference, in its entirety, into the present application.

### BACKGROUND OF THE INVENTION

### 1. Field of the Invention

The present invention relates to a material for a negative electrode, an electrode sheet for an all-solid state secondary battery, an all-solid state secondary battery, and methods for manufacturing an electrode sheet for an all-solid state secondary battery and an all-solid state secondary battery.

### 2. Description of the Related Art

For lithium ion batteries, electrolytic solutions have been used. Attempts are underway to produce all-solid state secondary batteries in which all constituent materials are solid by replacing electrolytic solutions with solid electrolytes. Reliability in terms of all performance of batteries is an advantage of techniques of using inorganic solid electrolytes. For example, to electrolytic solutions being used for lithium ion secondary batteries, flammable materials such as carbonate-based solvents are applied as media. In secondary batteries in which the above-described electrolytic solutions are used, a variety of safety measures are employed. However, there may be a concern that disadvantages may be caused during overcharging and the like, and there is a demand for additional efforts. All-solid state secondary batteries in which non-flammable electrolytes can be used are considered as a fundamental solution therefor.

Another advantage of all-solid state secondary batteries is the suitability for increasing energy density by means of the stacking of electrodes. Specifically, it is possible to produce batteries having a structure in which electrodes and electrolytes are directly arranged in series. At this time, metal packages sealing battery cells and copper wires or bus-bars connecting battery cells may not be provided, and thus the energy density of batteries can be significantly increased. In addition, favorable compatibility with positive electrode materials capable of increasing potentials and the like can also be considered as advantages.

Due to the respective advantages described above, all-solid state secondary batteries are being developed as next-generation lithium ion batteries (New Energy and Industrial Technology Development Organization (NEDO), Fuel Cell and Hydrogen Technologies Development Department, Electricity Storage Technology Development Section, “NEDO 2013 Roadmap for the Development of Next Generation Automotive Battery Technology” (August, 2013)). In order to suppress an increase in battery resistance and a decrease in discharge capacity, for example, JP2011-134675A describes an all-solid state secondary battery produced using an active material, a sulfide solid electrolyte material substantially not having crosslinked sulfur, and a hydrogenated rubber material.

### SUMMARY OF THE INVENTION

In the all-solid state secondary battery described in JP2011-134675A, the battery performance is improved by putting the interfaces between solid particles into a favorable state. However, in the all-solid state secondary battery described in JP2011-134675A, the unevenness of the distances between solid particles in the respective layers causes a problem in that the expansion and contraction of the volume of the active material caused by the repetition of charging and discharging deteriorates the interfaces between solid particles and cycle characteristics.

Therefore, an object of the present invention is to provide a material for a negative electrode which is capable of realizing favorable cycle characteristics in all-solid state secondary batteries and is excellent in terms of the dispersion stability of solid particles, an electrode sheet for an all-solid state secondary battery and an all-solid state secondary battery for which the material for a negative electrode is used, and methods for manufacturing an electrode sheet for an all-solid state secondary battery and an all-solid state secondary battery.

The present inventors and the like carried out intensive studies in order to achieve the above-described object and completed the present invention.

A material for a negative electrode which contains a carbonaceous material that is a negative electrode active material and an inorganic solid electrolyte and contains a non-conductive compound having a ring structure with three or more rings is excellent in terms of the dispersion stability of solid particles. Therefore, in negative electrode active material layers produced using this material for a negative electrode, the distances between solid particles constituting the negative electrode active material layers become uniform and favorable interfaces between the solid particles are formed. As a result, the present inventors found that all-solid state secondary batteries including the negative electrode active material layer are capable of realizing favorable cycle characteristics. The present invention is based on the above-described finding.

That is, the object is achieved by the following means.

<1> A material for a negative electrode comprising: a carbonaceous material that is a negative electrode active material, an inorganic solid electrolyte, and a non-conductive compound having a ring structure with three or more rings.

<2> The material for a negative electrode according to <1>, in which the non-conductive compound having a ring structure with three or more rings is a compound represented by General Formula (D) or a compound including a structure in which at least one hydrogen atom in the compound is substituted with a bond.

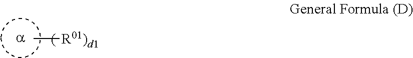

In General Formula (D), ring α represents a ring with three or more rings, R^{D1} represents a substituent bonded to a constituent atom of the ring α, and d1 represents an integer of 1 or more. In a case in which d1 is 2 or more, a plurality of R^{D1}'s may be identical to or different from each other. R^{D1}'s substituting atoms adjacent to each other may be bonded to each other and thus form a ring.

<3> The material for a negative electrode according to <2>, in which the compound represented by General Formula (D) is at least one compound selected from the group consisting of an aromatic hydrocarbon represented by General Formula (1), an aliphatic hydrocarbon represented by General Formula (2), and a compound having a structure in which at least one hydrogen atom in the aromatic hydrocarbon represented by General Formula (1) or the aliphatic hydrocarbon represented by General Formula (2) is substituted with bonds.

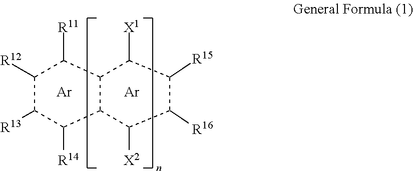

In General Formula (1), Ar represents a benzene ring. n represents an integer of 0 to 8. R¹¹ to R¹⁶ each independently represent a hydrogen atom or a substituent. X¹ and X² each independently represent a hydrogen atom or a substituent. Here, in R¹¹ to R¹⁶ and X¹ and X², groups adjacent to each other may be bonded to each other and thus form a five or six-membered ring. Here, in a case in which n is zero, any one substituent of R¹¹ to R¹³ is -(Ar¹)m-Rx or any two of R¹¹ to R¹³ are bonded to each other and thus form -(Ar¹)m-. Here, Ar¹ represents a phenylene group, m represents an integer of 2 or more, and Rx represents a hydrogen atom or a substituent. In addition, in a case in which n is one, in R¹¹ to R¹⁶ and X¹ and X², at least two atoms or substituents adjacent to each other are bonded to each other and thus form a benzene ring.

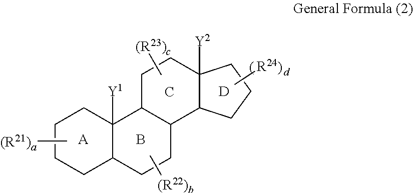

In General Formula (2), Y¹ and Y² each independently represent a hydrogen atom, a methyl group, or a formyl group. R²¹, R²², R²³, and R²⁴ each independently represent a substituent, and a, b, c, and d represent integers of 0 to 4.

Here, A ring may be a saturated ring, an unsaturated ring or aromatic ring having one or two double bonds, and B ring and C ring may be an unsaturated ring having one or two double bonds. Meanwhile, in a case in which the integer as each of a, b, c, and d is 2 to 4, substituents adjacent to each other may be bonded to each other and thus form a ring.

<4> The material for a negative electrode according to any one of <1> to <3>, further comprising a binder.

<5> The material for a negative electrode according to any one of <1> to <4>, in which the carbonaceous material that is a negative electrode active material is hard carbon or graphite.

<6> The material for a negative electrode according to any one of <1> to <5>, in which the inorganic solid electrolyte is a sulfide-based inorganic solid electrolyte.

<7> An electrode sheet for an all-solid state secondary battery produced by applying the material for a negative electrode according to any one of <1> to <6> onto a metal foil.

<8> An all-solid state secondary battery comprising: a positive electrode active material layer; a negative electrode active material layer; and an inorganic solid electrolyte layer, in which the negative electrode active material layer is produced by applying the material for a negative electrode according to any one of <1> to <6> to form a layer.

<9> A method for manufacturing an electrode sheet for an all-solid state secondary battery produced by applying the material for a negative electrode according to any one of <1> to <6> onto a metal foil.

<10> A method for manufacturing an all-solid state secondary battery, the method comprising: manufacturing an all-solid state secondary battery through the manufacturing method according to <9>.

In the present specification, numerical ranges expressed using “to” include numerical values before and after the “to” as the lower limit value and the upper limit value.

In the present specification, when a plurality of substituents represented by specific symbols is present or a plurality of substituents or the like is simultaneously or selectively determined (similarly, when the number of substituents is determined), the respective substituents and the like may be identical to or different from each other. In addition, a plurality of substituents or the like approximates to each other, the substituents or the like may be bonded or condensed to each other and thus form a ring.

In the present specification, “acryl” that is simply expressed is used to refer to both methacryl and acryl.

The material for a negative electrode of the present invention is excellent in terms of dispersion stability. In addition, all-solid state secondary batteries produced using the material for a negative electrode of the present invention exhibit an excellent effect enabling the realization of favorable cycle characteristics. In addition, the electrode sheet for an all-solid state secondary battery of the present invention can be preferably manufactured using the material for a negative electrode of the present invention and can be used for the all-solid state secondary battery of the present invention exhibiting the above-described favorable performance. Furthermore, the methods for manufacturing an electrode sheet for an all-solid state secondary battery and an all-solid state secondary battery of the present invention can be preferably used to manufacture the electrode sheet for an all-solid state secondary battery and the all-solid state secondary battery.

The above-described and other characteristics and advantages of the present invention will be further clarified by the following description with appropriate reference to the accompanying drawings.

### BRIEF DESCRIPTION OF THE DRAWINGS

FIG. 1 is a vertical cross-sectional view schematically illustrating an all-solid state lithium ion secondary battery according to a preferred embodiment of the present invention.

FIG. 2 is a vertical cross-sectional view schematically illustrating a testing device used in examples.

### DESCRIPTION OF THE PREFERRED EMBODIMENTS

An all-solid state secondary battery of the present invention includes a positive electrode active material layer, a negative electrode active material layer, and an inorganic solid electrolyte layer. In the present invention, the negative electrode active material layer is formed using a material for a negative electrode containing a carbonaceous material that is a negative electrode active material, an inorganic solid electrolyte, and at least one non-conductive compound having three or more rings.

Hereinafter, a preferred embodiment will be described.

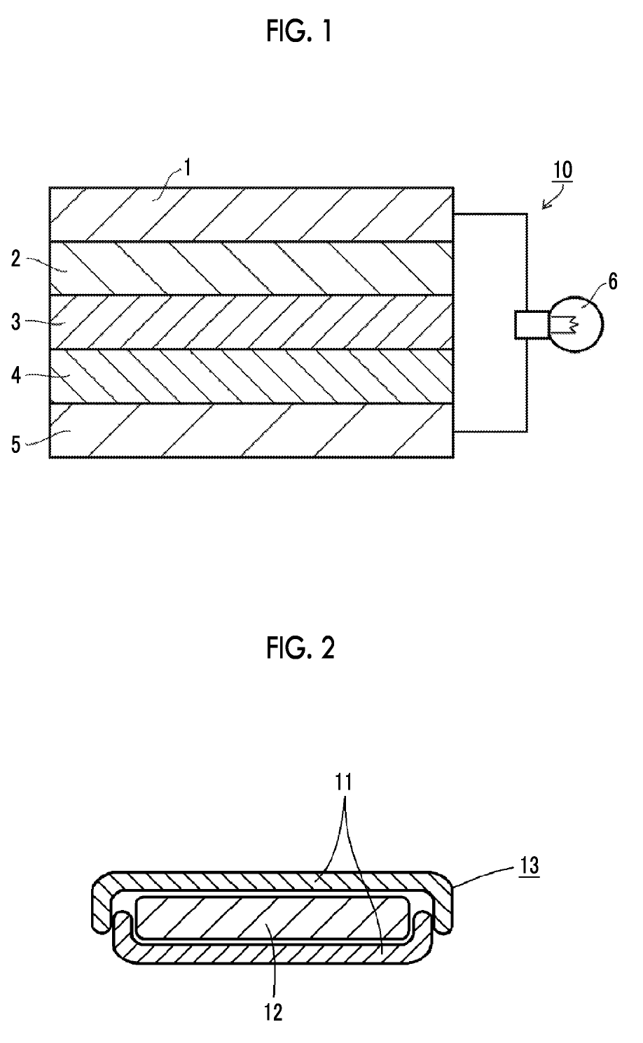

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the present invention, the thickness of at least one layer of the positive electrode active material layer 4, the solid electrolyte layer 3, and the negative electrode active material layer 2 is still more preferably 50 μm or more and less than 500 μm.

<<Material for Negative Electrode>>

Hereinafter, components contained in the material for a negative electrode of the present invention will be described. The material for a negative electrode of the present invention is preferably applied as a material used to form the negative electrode active material layer constituting the all-solid state secondary battery of the present invention.

In the present specification, in some cases, the positive electrode active material layer and the negative electrode active material layer will be referred to as the electrode layers. In addition, as electrode active materials that are used in the present invention, there are a positive electrode active material contained in the positive electrode active material layer and a negative electrode active material contained in the negative electrode active material layer, and there are cases in which either or both the positive electrode active material and the negative electrode active material will be simply referred to as the active materials.

(Inorganic Solid Electrolyte)

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (macromolecular electrolytes represented by PEO or the like and organic electrolyte salts represented by LiTFSI) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

In the present invention, the inorganic solid electrolyte has ion conductivity of metals belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes.

In the present invention, in the negative electrode active material layer, a sulfide-based inorganic solid electrolyte is preferably used since it is possible to form a more favorable interface between the negative electrode active material and the inorganic solid electrolyte.

(i) Sulfide-Based Inorganic Solid Electrolytes

Sulfide-based inorganic solid electrolytes are preferably inorganic solid electrolytes which contain sulfur atoms (S), have ion conductivity of metals belonging to Group I or II of the periodic table, and have electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (A).

Lₐ₁M_{b1}P_{c1}S_{d1}A_{c1} (A)

(In Formula (A), L represents an element selected from Li, Na, and K and is preferably Li. M represents an element selected from B, Zn, Sn, Si, Cu, Ga, Sb, Al, and Ge. Among these, B, Sn, Si, Al, and Ge are preferred, and Sn, Al, and Ge are more preferred. A represents I, Br, Cl, and F and is preferably I or Br and particularly preferably I. a1 to e1 represent the compositional ratios among the respective elements, and a1:b1:c1:d1:e1 satisfies 1 to 12:0 to 1:1:2 to 12:0 to 5. Furthermore, a1 is preferably 1 to 9 and more preferably 1.5 to 4. b1 is preferably 0 to 0.5. Furthermore, d1 is preferably 3 to 7 and more preferably 3.25 to 4.5. Furthermore, e1 is preferably 0 to 3 and more preferably 0 to 1.)

In Formula (A), the compositional ratios among L, M, P, S, and A are preferably b1=0 and e1=0, more preferably b1=0, e1=0, and the ratio among a1, c1, and d1 (a1:c1:d1)=1 to 9:1:3 to 7, and still more preferably b1=0, e1=0, and a1:c1:d1=1.5 to 4:1:3.25 to 4.5. The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of [1] lithium sulfide (Li₂S) and phosphorus sulfide (for example, phosphorus pentasulfide (P₂S₅)), [2] lithium sulfide and at least one of a phosphorus single body and a sulfur single body, or [3] lithium sulfide, phosphorus sulfide (for example, phosphorus pentasulfide (P₂S₅)), and at least one of a phosphorus single body and a sulfur single body.

The ratio between Li₂S and P₂S₅ in Li—P—S-based glass and Li—P—S-based glass ceramic is preferably 65:35 to 85:15 and more preferably 68:32 to 77:23 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

Specific examples of the compound include compounds formed using a raw material composition containing, for example, Li₂S and a sulfide of an element of Groups XIII to XV. Specific examples thereof include Li₂S—P₂S₅, Li₂S—LiI—P₂S₅, Li₂S—LiI—Li₂O—P₂S₅, Li₂S—LiBr—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₇S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅—LiI, Li₂S—SiS₂—LiI, Li₂S—SiS₂—Li₄SiO₄, Li₁₀GeP₂S₁₂, and the like. Among these, crystalline and/or amorphous raw material compositions consisting of Li₂S—P₂S₅, Li₂S—GeS₂—Ga₂S₃, Li₂S—SiS₂—P₂S₅, Li₂S—SiS₂—Li₃PO₄, Li₂S—LiI—Li₂O—P₂S₅, Li₂S—Li₂O—P₂S₅, Li₂S—Li₃PO₄—P₂S₅, Li₂S—GeS₂—P₂S₅, and Li₁₀GeP₂S₁₂ are preferred due to their high lithium ion conductivity. Examples of a method for synthesizing sulfide-based inorganic solid electrolyte materials using the above-described raw material compositions include an amorphorization method. Examples of the amorphorization method include a mechanical milling method and a melting quenching method. Among these, the mechanical milling method is preferred. This is because treatments at normal temperature become possible, and it is possible to simplify manufacturing steps.

(ii) Oxide-Based Inorganic Solid Electrolytes

Oxide-based inorganic solid electrolytes are preferably inorganic solid electrolytes which contain oxygen atoms (O), have an ion conductivity of metals belonging to Group I or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In and Sn, xb satisfies 5≦xb≦10, yb satisfies 1≦yb≦4, zb satisfies 1≦zb≦4, mb satisfies 0≦mb≦2, and nb satisfies 5≦nb≦20.), Li_{xc}B_{yc} M^{cc}_{zc}O_{nc} (M^{cc} is at least one of C, S, Al, Si, Ga, Ge, In, and Sn, xc satisfies 0≦xc≦5, yc satisfies 0≦yc≦1, zc satisfies 0≦zc≦0, and nc satisfies 0≦nc≦6, Li_{xd}(Al, Ga)_{yd}(Ti, Ge)_{zd}Si_{ad}P_{md}O_{nd} (1≦xd≦3, 0≦yd≦1, 0≦zd≦2, 0≦ad≦1, 1≦md≦7 3≦nd≦13), Li₍₃₋₂ₓₑ₎M^{cc}_{xc}D^{cc}O (xe represents a number of 0 or more and 0.1 or less, and M^{cc} represents a divalent metal atom. D^{cc} represents a halogen atom or a combination of two or more halogen atoms.), Li_{xf}Si_{yf}O_{zf} (1≦xf≦5, 0≦yf≦3, 1≦zf≦10), Li_{xg}S_{yg}O_{zg} (1≦xg≦3, 0≦yg≦2, 1≦zg≦10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≦xh≦1, 0≦yh≦1), Li₇La₃Zr₂O₁₂ having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one selected from Ti, V, Cr, Mn, Fe, Co, Ni, Cu, Zr, Nb, Mo, Ru, Ag, Ta, W, Pt, Au, and the like), and the like. It is also possible to preferably use LiA¹ON (A¹ represents at least one selected from Si, B, Ge, Al, C, Ga, and the like) and the like.

The volume-average particle diameter of the inorganic solid electrolyte is not particularly limited, but is preferably 0.01 μm or more and more preferably 0.1 μm or more. The upper limit is preferably 100 μm or less and more preferably 50 μm or less. Meanwhile, the average particle diameter of the inorganic solid electrolyte is measured in the following order. One percent by mass of a dispersion liquid is prepared using inorganic solid electrolyte particles and water (heptane in a case in which the inorganic solid electrolyte is unstable in water) in a 20 ml sample bottle by means of dilution. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering method” is referred to as necessary. Five specimens are produced per level, and the average values thereof are employed.

When the satisfaction of both battery performance and an effect of decreasing and maintaining interface resistance are taken into account, the concentration of the inorganic solid electrolyte in the solid components of the material for a negative electrode is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

Meanwhile, the solid components in the present specification refer to components that do not disappear through volatilization or evaporation when dried at 170° C. for six hours. Typically, the solid components refer to components other than a dispersion medium described below.

These inorganic solid electrolytes may be used singly or two or more inorganic solid electrolytes may be used in combination.

(Binder)

The material for a negative electrode of the present invention may also contain a binder.

The binder that is used in the present invention is not particularly limited as long as the binder is an organic polymer.

The binder that can be used in the present invention is preferably a binder that is generally used as binding agents for positive electrodes or negative electrodes of battery materials, is not particularly limited, and is preferably, for example, a binder consisting of resins described below.

Examples of fluorine-containing resins include polytetrafluoroethylene (PTFE), polyvinylene difluoride (PVdF), and copolymers of polyvinylene difluoride and hexafluoropropylene (PVdF-HFP).

Examples of hydrocarbon-based thermoplastic resins include polyethylene, polypropylene, styrene butadiene rubber (SBR), hydrogenated styrene butadiene rubber (HSBR), butylene rubber, acrylonitrile butadiene rubber, polybutadiene, and polyisoprene.

Examples of acrylic resins include polymethyl (meth)acrylate, polyethyl (meth)acrylate, polyisopropyl (meth)acrylate, polyisobutyl (meth)acrylate, polybutyl (meth)acrylate, polyhexyl (meth)acrylate, polyoctyl (meth)acrylate, polydodecyl (meth)acrylate, polystearyl (meth)acrylate, poly 2-hydroxyethyl (meth)acrylate, poly(meth)acrylic acid, polybenzyl (meth)acrylate, polyglycidyl (meth)acrylate, polydimethylaminopropyl (meth)acrylate, and copolymers of monomers constituting the above-described resins.

In addition, copolymers with other vinyl-based monomers are also preferably used. Examples thereof include polymethyl (meth)acrylate-polystyrene copolymers, polymethyl (meth)acrylate-acrylonitrile copolymers, and polybutyl (meth)acrylate-acrylonitrile-styrene copolymers. In the present invention, HSBR is preferably used.

These binders may be used singly or two or more binders may be used in combination.

The moisture concentration of a polymer constituting the binder that is used in the present invention is preferably 100 ppm (mass-based).

In addition, the polymer constituting the binder that is used in the present invention may be dried by being crystallized or may be used in a polymer solution form. The amount of a metal-based catalyst (an urethanization or polyesterification catalyst: tin, titanium, or bismuth) is preferably small. The concentration of metal in copolymers is preferably set to 100 ppm or less (mass-based) by decreasing the amount of the metal during polymerization or removing the catalyst by means of crystallization.

The solvent that is used for the polymerization reaction of the polymer is not particularly limited. Meanwhile, solvents that do not react with the inorganic solid electrolyte or the active materials and furthermore do not decompose the inorganic solid electrolyte or the active materials are desirably used. For example, it is possible to use hydrocarbon-based solvents (toluene, heptane, and xylene), ester-based solvents (ethyl acetate and propylene glycol monomethyl ether acetate), ether-based solvents (tetrahydrofuran, dioxane, and 1,2-diethoxyethane), ketone-based solvents (acetone, methyl ethyl ketone, and cyclohexanone), nitrile-based solvents (acetonitrile, propionitrile, butyronitrile, and isobutyronitrile), and halogen-based solvents (dichloromethane and chloroform).

The mass average molecular weight of the polymer constituting the binder that is used in the present invention is preferably 10,000 or more, more preferably 20,000 or more, and still more preferably 50,000 or more. The upper limit is preferably 1,000,000 or less, more preferably 200,000 or less, and still more preferably 100,000 or less.

In the present invention, the molecular weight of the polymer refers to the mass average molecular weight unless particularly otherwise described. The mass average molecular weight can be measured as the polystyrene-equivalent molecular weight by means of GPC. At this time, the polystyrene-equivalent molecular weight is detected as RI using a GPC apparatus HLC-8220 (manufactured by Tosoh Corporation) and G3000HXL+G2000HXL as columns at a flow rate at 23° C. of 1 mL/min. An eluent can be selected from tetrahydrofuran (THF), chloroform, N-methyl-2-pyrrolidone (NMP), and m-cresol/chloroform (manufactured by Shonanwako Junyaku KK), and THF is used in a case in which the polymer needs to be dissolved.

In a case in which favorable interface resistance-reducing and maintaining properties are taken into account when the binder is used in the all-solid state secondary battery, the concentration of the binder in the material for a negative electrode is preferably 0.01% by mass or more, more preferably 0.1% by mass or more, and still more preferably 1% by mass or more with respect to 100% by mass of the solid components. From the viewpoint of battery characteristics, the upper limit is preferably 10% by mass or less, more preferably 5% by mass or less, and still more preferably 3% by mass or less.

In the present invention, the mass ratio [(the mass of the inorganic solid electrolyte+the mass of the negative electrode active material)/the mass of the binder] of the total mass of the inorganic solid electrolyte and the negative electrode active material to the mass of the binder is preferably in a range of 1,000 to 1. This ratio is more preferably 500 to 2 and still more preferably 100 to 10.

(Lithium Salt)

The solid electrolyte composition of the present invention also preferably contains a lithium salt.

The lithium salt is preferably a lithium salt that is ordinarily used in this kind of products, is not particularly limited, and is preferably, for example, the lithium salt described in Paragraphs 0082 to 0085 of JP2015-088486A.

The content of the lithium salt is preferably 0 parts by mass or more and more preferably 5 parts by mass or more with respect to 100 parts by mass of the solid electrolyte. The upper limit is preferably 50 parts by mass or less and more preferably 20 parts by mass or less.

(Auxiliary Conductive Agent)

Next, an auxiliary conductive agent that can be used in the solid electrolyte composition of the present invention will be described. Auxiliary conductive agents that are known as ordinary auxiliary conductive agents can be used. The auxiliary conductive agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene and also may be metal powder or a metal fiber of copper, nickel, or the like, all of which are electron-conductive materials, and a conductive macromolecule such as polyaniline, polypyrrole, polythiophene, polyacetylene, or a polyphenylene derivative may also be used. In addition, these auxiliary conductive agents may be used singly or two or more auxiliary conductive agents may be used.

In the present invention, a carbonaceous material is used as the negative electrode active material, and the carbonaceous material is a material substantially consisting of carbon. Examples thereof include petroleum pitch, hard carbon, graphite (natural graphite, artificial graphite such as highly oriented pyrolytic graphite, and the like), and carbonaceous material obtained by firing a variety of synthetic resins such as PAN-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated PVA-based carbon fibers, lignin carbon fibers, glassy carbon fibers, and active carbon fibers, mesophase microspheres, flat graphite, and the like.

In the present invention, hard carbon or graphite is preferably used, and graphite is more preferably used. Meanwhile, in the present invention, the carbonaceous material may be used singly or two or more carbonaceous materials may be used in combination.

The average particle size of the negative electrode active material is preferably 0.1 μm to 60 μm. In order to provide a predetermined particle size, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out.

The concentration of the negative electrode active material is not particularly limited, but is preferably 10 to 80% by mass and more preferably 20 to 70% by mass with respect to 100% by mass of the solid components in the material for a negative electrode.

The mass (mg) (basis weight) of the negative electrode active material per unit area (cm²) of the negative electrode active material layer is not particularly limited. The mass can be arbitrarily determined depending on the designed battery capacity.

The negative electrode active material may be used singly or two or more negative electrode active materials may be used in combination.

(Non-Conductive Compound Having Ring Structure with Three or More Rings)

Next the non-conductive compound having a ring structure with three or more rings that is used in the present invention will be described.

Here, “being non-conductive” means that the electric conductivity of the compound is 1×10⁻⁶ S/m or less. The electric conductivity can be measured using a method described below.

(1) An organic solvent dispersion of the compound is applied and dried on a polyphenylene sulfone sheet film five times and is peeled off from the polyphenylene sulfone sheet film, thereby obtaining an independent film.

(2) The surface resistivity R (Ω/sq.) of the independent film is measured using a surface resistance measurement instrument (trade name “HIRESTA-UX MCP-HT800”, manufactured by Mitsubishi Chemical Analytech Co., Ltd.).

Meanwhile, the film thickness d (μm) of the independent film is measured using a micrometer.

(3) The electric conductivity (S/m) can be computed from the following expression using the surface resistivity R and the film thickness d.

Electric conductivity=(1/R)/(d×10⁻⁶)

In the present invention, the non-conductive compound having a ring structure with three or more rings is preferably used as a dispersant singly or in combination with other components as necessary.

In the case of containing the non-conductive compound having a ring structure with three or more rings, a composition for a negative electrode of the present invention is excellent in terms of dispersion stability and is capable of evening the distances between solid particles in the negative electrode active material layer formed by applying the composition onto a metal foil. Therefore, the all-solid state secondary battery produced using the negative electrode active material layer is excellent in terms of cycle characteristics.

The non-conductive compound having a ring structure with three or more rings which is used in the present invention is preferably a compound represented by General Formula (D) or a compound including a structure in which at least one hydrogen atom in the compound is substituted with a bond.

The above-described compound is excellent in terms of affinity to the carbonaceous material and is thus capable of improving the dispersion stability of the solid electrolyte composition containing this compound. The improvement of the dispersion stability is accompanied by the all-solid state secondary battery produced using the solid electrolyte composition being excellent in terms of cycle characteristics.

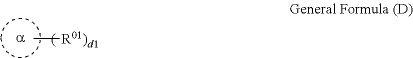

In General Formula (D), ring α represents a ring with three or more rings, R^{D1} represents a substituent bonded to a constituent atom of the ring α, and d1 represents an integer of 1 or more. In a case in which d1 is 2 or more, a plurality of R^{D1}'s may be identical to or different from each other. R^{D1}'s substituting atoms adjacent to each other may be bonded to each other and thus form a ring. The ring α is preferably a three- or more-membered ring and more preferably a four- or more-membered ring. In addition, the ring α is preferably a 18- or less-membered ring, more preferably a 16- or less-membered ring, and particularly preferably a 12- or less-membered ring.

The compound including a structure in which at least one hydrogen atom in the compound represented by General Formula (D) is substituted with a bond “-” is not limited as long as compounds include a structure in which at least one hydrogen atom in the compound represented by General Formula (D) is substituted with a bond “-”. For example, in a case in which a substituent in the ring α is —OH, compounds including a structure in which the hydrogen atom from the ring α-OH is substituted with a bond “-”, that is, a partial structure of the ring α-O— can be considered as the above-described compound.

The compound including the structure in which at least one hydrogen atom in the compound represented by General Formula (D) is substituted with a bond “-” may be a derivative (monomer) of the compound represented by General Formula (D) or a polymer including an oligomer.

Hereinafter, the compound including the structure in which at least one hydrogen atom in the compound represented by General Formula (D) is substituted with a bond “-” will be referred to as the compound including a partial structure represented by General Formula (D).

In the case of the derivative, to the bond that has substituted a hydrogen atom, a group other than hydrogen atoms, that is, a substituent is bonded.

Here, the derivative (monomer) refers to a compound derived by the esterification, etherification, or the like of a hydroxy group and the esterification, amidation, or the like of a carboxy group occurring in a hydroxy group and an alkyl group substituted with a reactive group such as a hydroxy group or a carboxy group among substituents as R^{D1}.

In the present invention, the compound including the partial structure represented by General Formula (D) is preferably a polymer including an oligomer.

The partial structure represented by General Formula (D) may be included in any of the main chain or a side chain of the polymer and a polymer terminal.

In the partial structure represented by General Formula (D), to the front of the bond “-”, for example, the polymer including an oligomer may be bonded as a residue.

Meanwhile, the partial structure being included in the main chain of the polymer means that a structure in which at least two hydrogen atoms in the compound represented by General Formula (D) are substituted with bonds is combined into the polymer and serves as a chain that becomes the repeating structure of the polymer. On the other hand, the partial structure being included in a side chain of the polymer means that a structure in which one hydrogen atom in the compound represented by General Formula (D) is substituted with a bond is combined into the polymer and is bonded to the main chain of the polymer through only one bond, and the partial structure being included in a polymer terminal means that a structure in which one hydrogen atom in the compound represented by General Formula (D) is substituted with a bond is combined into the polymer and is present in a terminal of a polymer chain. Here, the partial structure may be included in a plurality of the main chains or side chains of the polymer or a plurality of polymer terminals.

In the present invention, the main chain or a side chain is preferred, and a side chain is more preferred.

In the present invention, the mass average molecular weight of the compound including the structure in which at least one hydrogen atom in the compound represented by General Formula (D) is substituted with a bond is preferably 180 to 100,000, more preferably 190 to 80,000, and particularly preferably 200 to 60,000. The mass average molecular weight can be obtained in the same manner as the method for measuring the mass average molecular weight of the binder described in examples below.

In addition, in the present invention, the compound represented by General Formula (D) is preferably at least one compound selected from the group consisting of the aromatic hydrocarbon represented by General Formula (1), the aliphatic hydrocarbon represented by General Formula (2), and a compound having a structure in which at least one hydrogen atom in the aromatic hydrocarbon or aliphatic hydrocarbon is substituted with a bond in the repeating unit.

The compound selected from the group consisting of the aromatic hydrocarbon represented by General Formula (1), the aliphatic hydrocarbon represented by General Formula (2), and a compound having a structure in which at least one hydrogen atom in the aromatic hydrocarbon or aliphatic hydrocarbon is substituted with a bond in the repeating unit is excellent in terms of the affinity to the carbonaceous material that is a negative electrode active material. Therefore, it is possible to further improve the dispersion stability of the solid electrolyte composition containing these compounds. In addition, the improvement of the dispersion stability enables the all-solid state secondary battery produced using the solid electrolyte composition to be excellent in terms of cycle characteristics.

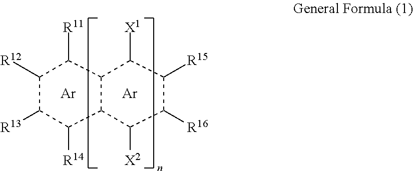

In General Formula (1), Ar represents a benzene ring. n represents an integer of 0 to 8. R¹¹ to R¹⁶ each independently represent a hydrogen atom or a substituent. X¹ and X² each independently represent a hydrogen atom or a substituent. Here, in R¹¹ to R¹⁶ and X¹ and X², groups adjacent to each other may be bonded to each other and thus form a five or six-membered ring. Here, in a case in which n is zero, any one substituent of R¹¹ to R¹⁶ is -(Ar¹)m-Rx or any two of R¹¹ to R¹⁶ are bonded to each other and thus form -(Ar¹)m-. Here, Ar¹ represents a phenylene group, m represents an integer of 2 or more, and Rx represents a hydrogen atom or a substituent. In addition, in a case in which n is one, in R¹¹ to R¹⁶ and X¹ and X², at least two atoms or substituents adjacent to each other are bonded to each other and thus form a benzene ring.

Examples of the substituents represented by R¹¹ to R¹⁶ include an alkyl group, an aryl group, a heteroaryl group, an alkenyl group, an alkynyl group, an alkoxy group, an aryloxy group, a heteroaryloxy group, an alkylthio group, an arylthio group, a heteroarylthio group, an acyl group, an acyloxy group, an alkoxycarbonyl group, an aryloxycarbonyl group, an alkylcarbonyloxy group, an arylcarbonyoxy group, a hydroxy group, a carboxy group or salts thereof, a sulfo group or salts thereof, an amino group, a mercapto group, an amide group, a formyl group, a cyano group, a halogen atom, a (meth)acryl group, a (meth)acryloyloxy group, a (meth)acrylamide group, an epoxy group, an oxetanyl group, and the like.

Meanwhile, hereinafter, a formyl group will be described as a part of an acyl group.

The number of carbon atoms in the alkyl group is preferably 1 to 30, more preferably 1 to 25, and particularly preferably 1 to 20. Specific examples thereof include methyl, ethyl, propyl, isopropyl, butyl, t-butyl, octyl, dodecyl, stearyl, benzyl, naphthylmethyl, pyrenylmethyl, and pyrenylbutyl. The alkyl group more preferably contains an unsaturated carbon bond of a double bond or a triple bond therein.

The number of carbon atoms in the aryl group is preferably 6 to 30, more preferably 6 to 26, and particularly preferably 6 to 15. Specific examples thereof include phenyl, naphthyl, anthracene, terphenyl, tolyl, xylyl, methoxyphenyl, cyanophenyl, and nitrophenyl.

The number of carbon atoms in the heteroaryl group is preferably 1 to 30, more preferably 1 to 26, and particularly preferably 1 to 15. Specific examples of heteroaryl in the heteroaryl group include furan, pyridine, thiophene, pyrrole, triazine, imidazole, tetrazole, pyrazole, thiazole, and oxazole.

The number of carbon atoms in the alkenyl group is preferably 2 to 30, more preferably 2 to 25, and particularly preferably 2 to 20. Specific examples thereof include vinyl and 1-propenyl.

The number of carbon atoms in the alkynyl group is preferably 2 to 30, more preferably 2 to 25, and particularly preferably 2 to 20. Specific examples thereof include ethynyl, 2-propynyl, and phenylethynyl.
Alkoxy group: the alkyl group constituting the alkoxy group is the same as the above-described alkyl group.
Aryloxy group: the aryl group constituting the aryloxy group is the same as the above-described aryl group.
Heteroaryloxy group: the heteroaryl group constituting the heteroaryloxy group is the same as the above-described heteroaryl group.
Alkylthio group: the alkyl group constituting the alkylthio group is the same as the above-described alkyl group.
Arylthio group: the aryl group constituting the arylthio group is the same as the above-described aryl group.
Heteroarylthio group: the heteroaryl group constituting the heteroarylthio group is the same as the above-described heteroaryl group.
Acyl group: the number of carbon atoms is preferably 1 to 30, more preferably 1 to 25, and still more preferably 1 to 20. The acyl group includes a formyl group, an aliphatic carbonyl group, an aromatic carbonyl group, or a heterocyclic carbonyl group. Examples thereof include the following groups.

Formyl, acetyl (methyl carbonyl), benzoyl (phenylcarbonyl), ethylcarbonyl, acryloyl, methacryloyl, octylcarbonyl, dodecylcarbonyl (stearic acid residue), a linoleic acid residue, and a linolenic acid residue
Acyloxy group: the acyl group constituting the acyloxy group is the same as the above-described acyl group.
Alkoxycarbonyl group: the number of carbon atoms is preferably 2 to 30, more preferably 2 to 25, and still more preferably 2 to 20. Specific examples of the alkyl group constituting the alkoxycarbonyl group include the specific examples of the above-described alkyl group.
Aryloxycarbonyl group: the number of carbon atoms is preferably 7 to 30, more preferably 7 to 25, and still more preferably 7 to 20. Specific examples of the aryl group constituting the aryloxycarbonyl group include the specific examples of the above-described aryl group.
Alkylcarbonyloxy group: the number of carbon atoms is preferably 2 to 30, more preferably 2 to 25, and still more preferably 2 to 20. Specific examples of the alkyl group constituting the alkylcarbonyloxy group include the specific examples of the above-described alkyl group.
Arylcarbonyloxy group: the number of carbon atoms is preferably 7 to 30, more preferably 7 to 25, and still more preferably 7 to 20. Specific examples of the aryl group constituting the arylcarbonyloxy group include the specific examples of the above-described aryl group.

These substituents, generally, can be introduced by the electrophilic substitution reaction, nucleophilic substitution reaction, halogenation, sulfonation, or diazotization of the aromatic hydrocarbon represented by General Formula (1) or a combination thereof. Examples thereof include alkylation by the Friedel-Crafts reaction, acylation by the Friedel-Crafts reaction, the Vilsmeier-Haack reaction, transition metal catalyst coupling reactions, and the like.

n is preferably an integer of 0 to 6 and particularly preferably an integer of 1 to 4.

The aromatic hydrocarbon represented by General Formula (1) is preferably a compound represented by General Formula (1-1) or (1-2).

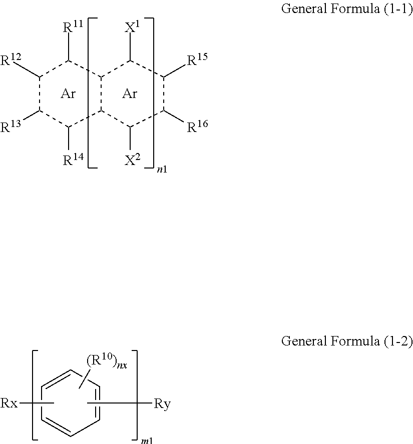

In General Formula (1-1), Ar, R¹¹ to R¹⁶, and X¹ and X² are the same as Ar, R¹¹ to R¹⁶, and X¹ and X² in General Formula (1), and preferred ranges thereof are also identical. n1 represents an integer of 1 or more. Here, in a case in which n1 is one, in R¹¹ to R¹⁶ and X¹ and X², at least two atoms or substituents adjacent to each other are bonded to each other and thus form a benzene ring.

In General Formula (1-2), Rx is the same as Rx in General Formula (1), and a preferred range thereof is also identical. R¹⁰ represents a substituent, and nx represents an integer of 0 to 4. m1 represents an integer of 3 or more. Ry represents a hydrogen atom or a substituent. Here, Rx and Ry may be bonded to each other.

n1 is preferably an integer of 1 to 6, more preferably an integer of 1 to 3, and particularly preferably an integer of 1 or 2.

m1 is preferably an integer of 3 to 10, more preferably an integer of 3 to 8, and particularly preferably an integer of 3 to 5.

Specific examples of the aromatic hydrocarbon represented by General Formula (1) include anthracene, phenanthracene, pyrene, tetracene, tetraphene, chrysene, triphenylene, pentacene, pentaphene, perylene, benzo[a]pyrene, coronene, anthanthrene, coranurene, ovalene, graphene, cycloparaphenylene, polyparaphenylene, and cyclophene. However, the present invention is not limited thereto.

The compound including a partial structure represented by General Formula (1) preferably has a polar functional group (particularly, a hydroxy group, a carboxy group or a salt thereof, a sulfo group or a salt thereof, an amino group, or a cyano group).

The compound including the partial structure represented by General Formula (1) preferably has a long-chain alkyl group (having 8 to 30 carbon atoms) that can be dispersed in hydrocarbon-based solvents.

The compound more preferably contains the polar functional group and the long-chain alkyl group.

In the case of the polymer, copolymerized polymers having a repeating structure obtained from monomers having a polar functional group as a copolymerization component in addition to a repeating unit including the partial structure represented by General Formula (1) are preferred. In addition, copolymerized polymers having a repeating structure obtained from monomers having a long-chain alkyl group (having 8 to 30 carbon atoms) that can be dispersed in hydrocarbon-based solvents as a copolymerization component are also preferred. The polymer more preferably contains a repeating unit obtained from monomers having a polar functional group and a repeating unit obtained from monomers having a long-chain alkyl group.

Specific examples of the compound including the structure in which at least one hydrogen atom in the aromatic hydrocarbon represented by General Formula (1) is substituted with a bond include the following compounds. However, the present invention is not limited thereto.

Meanwhile, in the repeating unit of the polymer, x, y, and z have a unit of mol % and have a numerical value of 1 to 100. The total is 100.

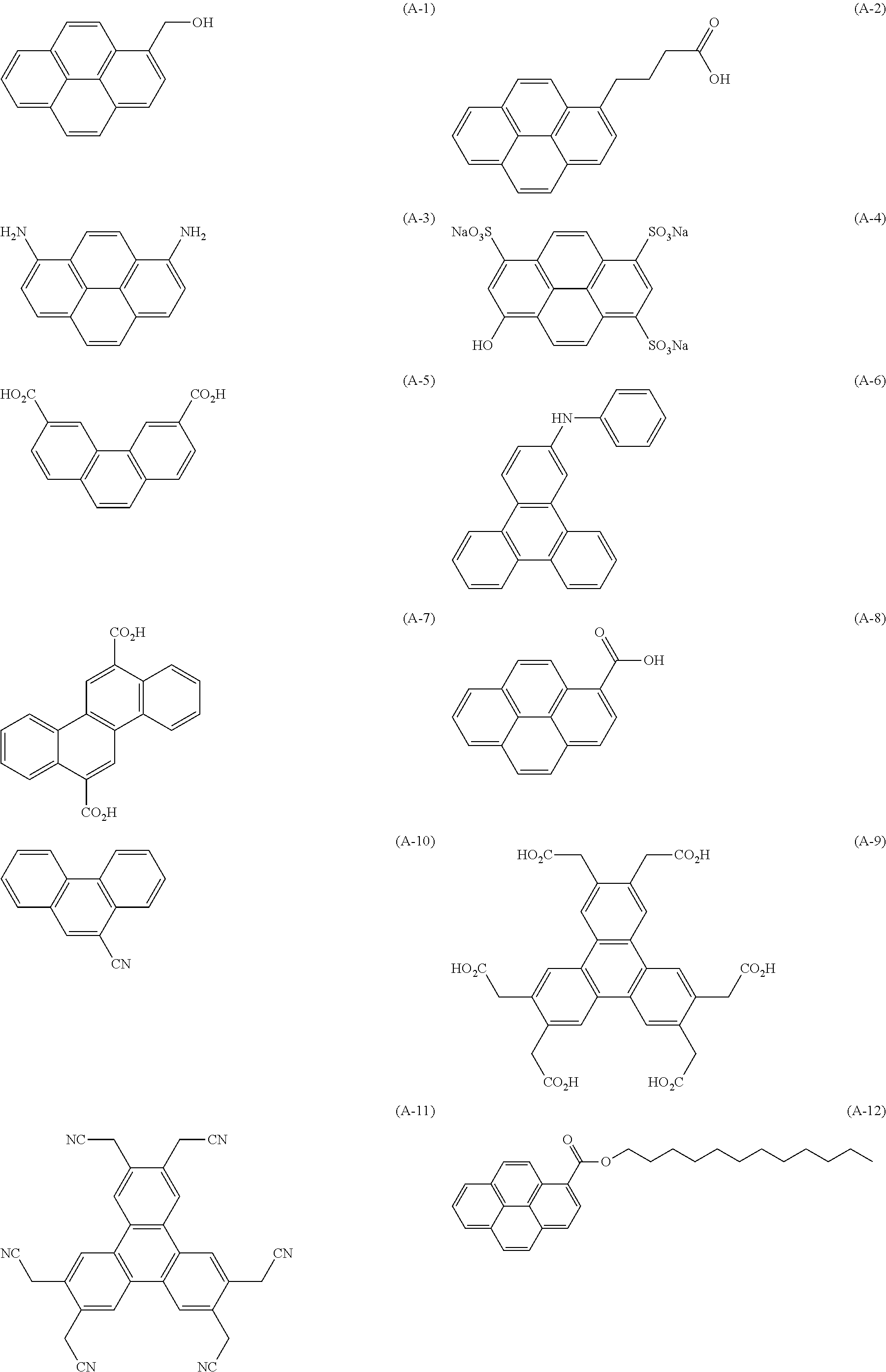

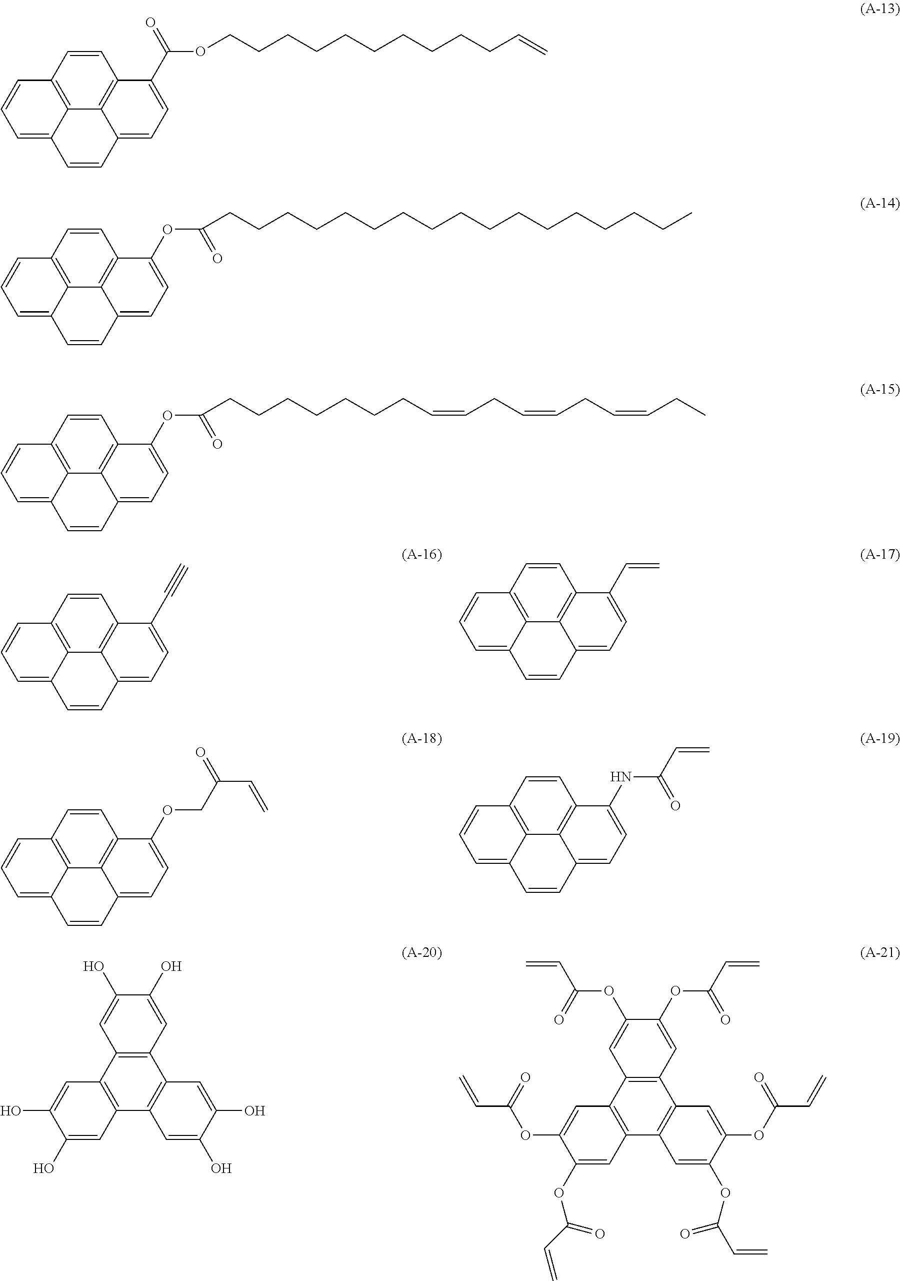

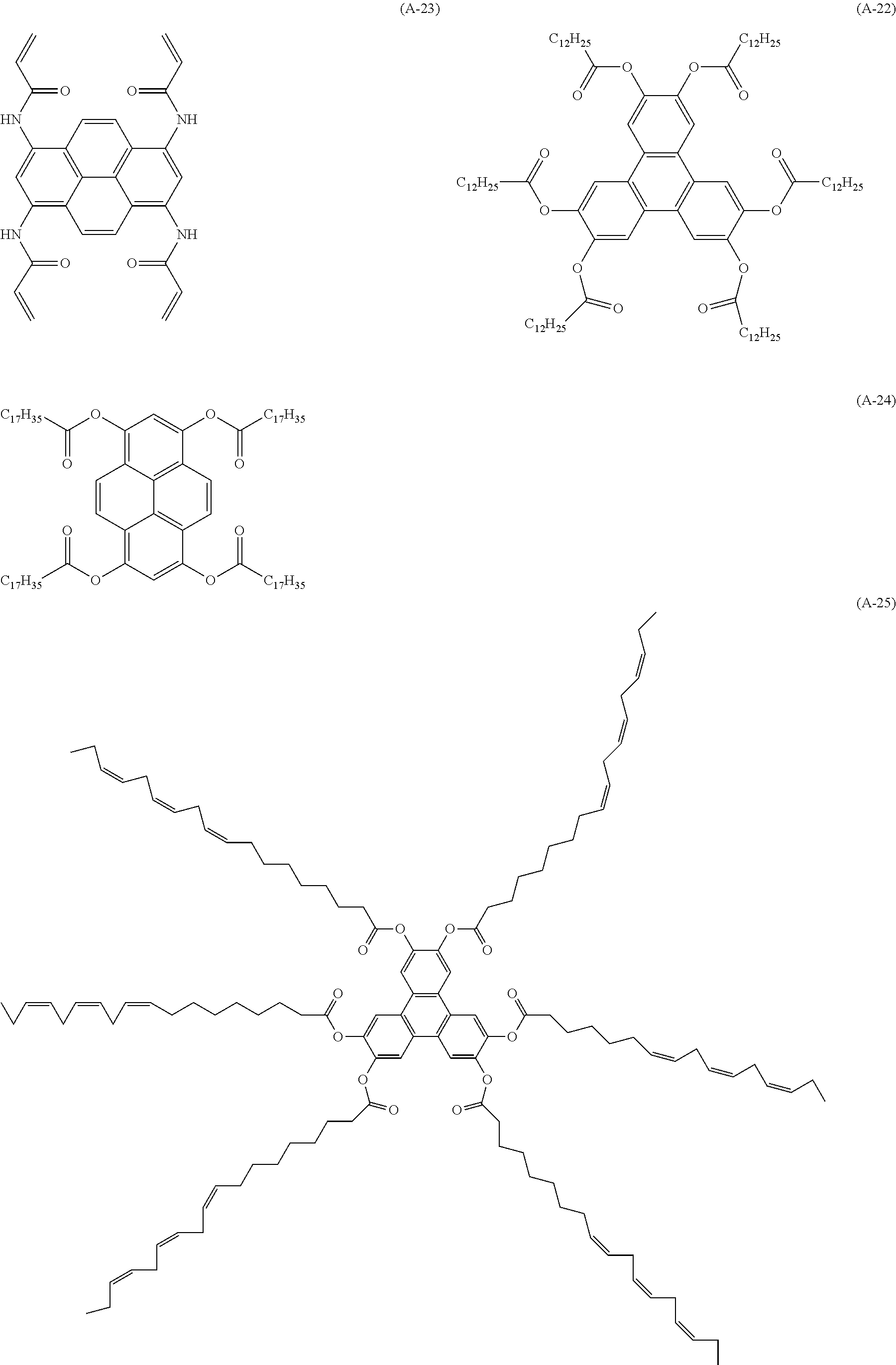

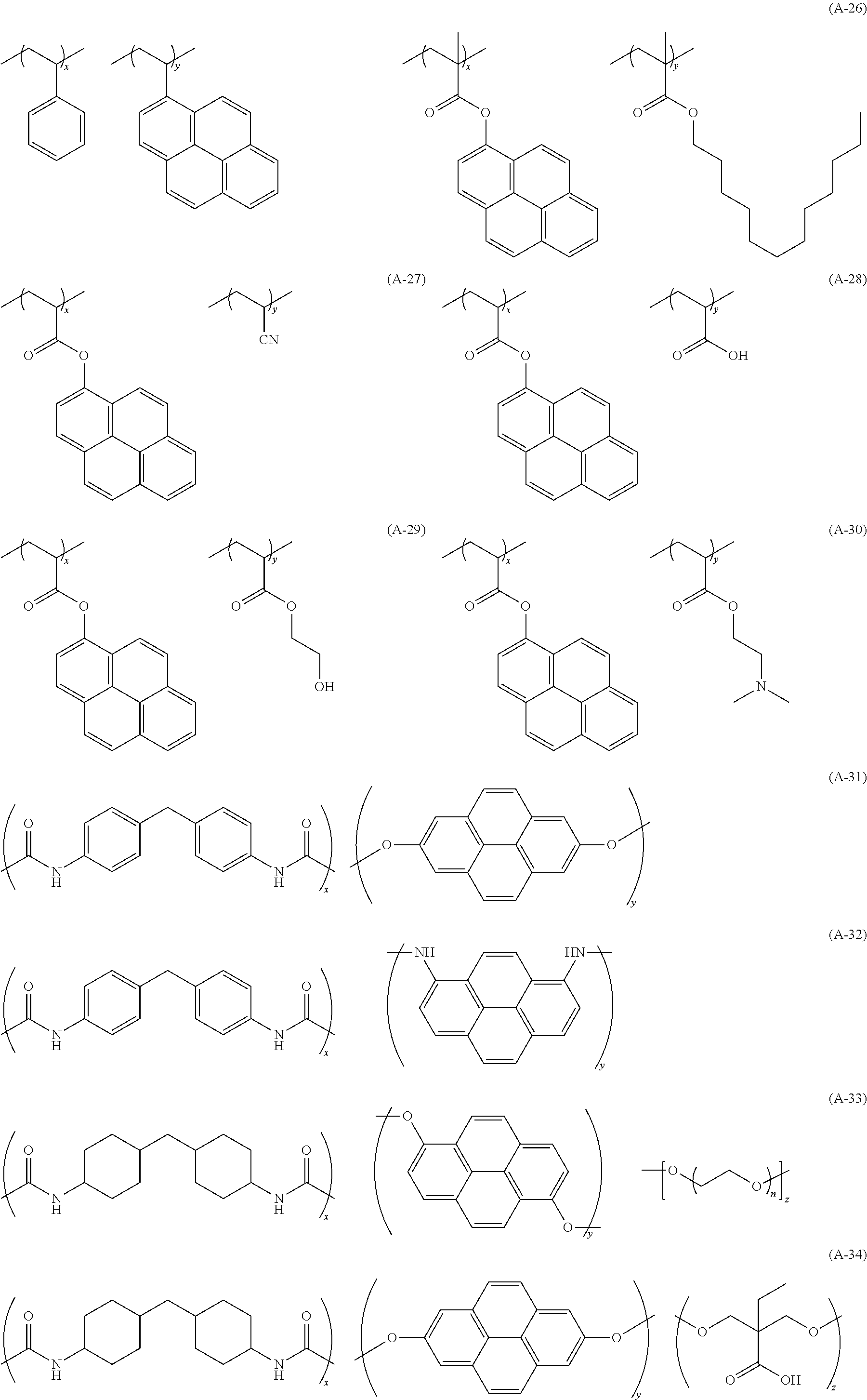

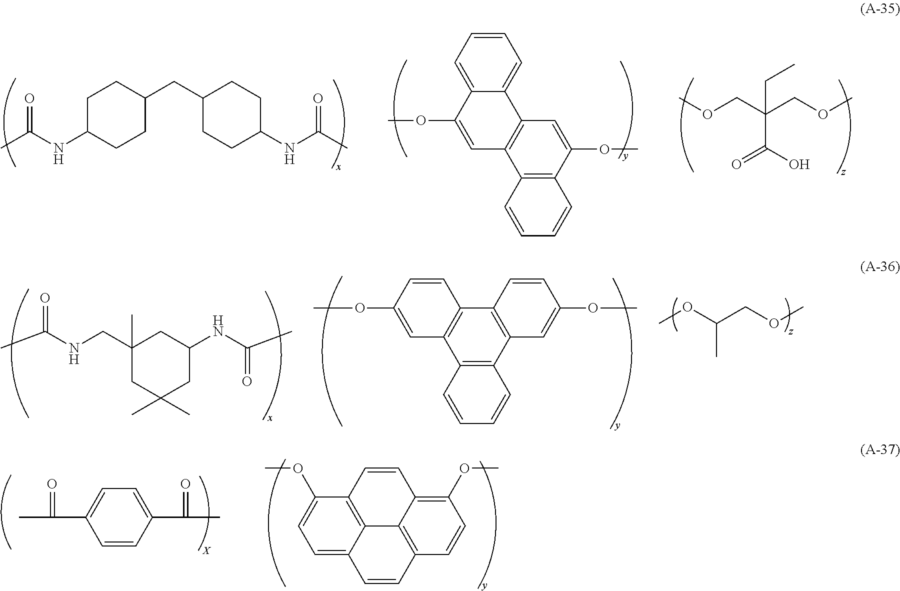

As the aromatic hydrocarbon represented by General Formula (1), commercially available products can be used.

In addition, the compound including the structure in which at least one hydrogen atom in the aromatic hydrocarbon represented by General Formula (1) is substituted with a bond (the compound including the partial structure represented by General Formula (1)) can be synthesized using an ordinary method. For example, the compound can be synthesized in the following manner.

The substituent that the compound including the partial structure represented by General Formula (1) has, generally, can be introduced by the electrophilic substitution reaction, nucleophilic substitution reaction, halogenation, sulfonation, or diazotization of the aromatic hydrocarbon represented by General Formula (1) or a combination thereof. Examples thereof include alkylation by the Friedel-Crafts reaction, acylation by the Friedel-Crafts reaction, the Vilsmeier-Haack reaction, transition metal catalyst coupling reactions, and the like.

In commercially available products, hydroxy groups, amino groups, carboxy groups, sulfo groups, and the like which are directly bonded to aromatic rings can be substituted with other substituents by means of an ordinary organic synthesis (for example, alkylation, arylation, acylation, or the like which is a nucleophilic substitution reaction).

The polymer including the partial structure represented by General Formula (1) can be obtained by synthesizing monomers including the partial structure represented by General Formula (1) and applying an ordinary polymerization method thereof.

For example, monomers including the partial structure represented by General Formula (1) which have a radical polymerizable unsaturated double bond are synthesized using the above-described method and are radical-polymerized in the presence of a radical polymerization initiator, whereby polymers having carbon chains in the main chain can be obtained.

Monomers including the partial structure represented by General Formula (1) which have a cationic polymerizable cyclic ether functional group (—O—) are synthesized using the above-described method and are cationic-polymerized in the presence of a cationic polymerization initiator, whereby polymers having ether groups in the main chain can be obtained.

Monomers including the partial structure represented by General Formula (1) which have a two or more-substituted hydroxy group, amino group, or carboxy group are condensation-polymerized in the presence of a condensation catalyst (for example, a bismuth catalyst or a tin catalyst), whereby condensable polymers such as polyester, polyamide, polyurethane, and polyimide can be obtained.

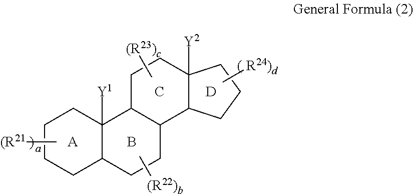

In General Formula (2), Y¹ and Y² each independently represent a hydrogen atom, a methyl group, or a formyl group. R²¹, R²², R²³, and R²⁴ each independently represent a substituent, and a, b, c, and d represent integers of 0 to 4.

Here, A ring may be a saturated ring, an unsaturated ring or aromatic ring having one or two double bonds, and B ring and C ring may be an unsaturated ring having one or two double bonds. Meanwhile, in a case in which the integer as each of a, b, c, and d is 2 to 4, substituents adjacent to each other may be bonded to each other and thus form a ring.

The aliphatic hydrocarbon represented by General Formula (2) is a compound having a steroidal skeleton.

Here, the carbon numbers in the steroidal skeleton are as described below.

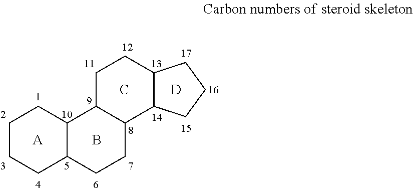

Firstly, the aliphatic hydrocarbon represented by General Formula (2) will be described.

The substituents as R²¹, R²², R²³, and R²⁴ may be any substituents, but an alkyl group, an alkenyl group, a hydroxy group, a formyl group, an acyl group, a carboxy group or a salt thereof, a (meth)acryl group, a (meth)acryloyl group, a (meth)acryloyloxy group, a (meth)acrylamide group, an epoxy group, or an oxetanyl group is preferred, and a ═O group in which two substituents substituting the same carbon atom are commonly formed is preferred.

The alkyl group is preferably an alkyl group having 1 to 12 carbon atoms and may have a substituent. The substituent may be any substituent, and examples thereof include an alkyl group, an alkenyl group, a hydroxy group, a formyl group, an acyl group, a carboxy group, an alkoxycarbonyl group, a carbamoyl group, and a sulfo group. The alkyl group more preferably contains an unsaturated carbon bond of a double bond or a triple bond therein.

The alkenyl group is preferably an alkenyl group having 1 to 12 carbon atoms and may have a substituent. The substituent may be any substituent, and examples thereof include an alkyl group, an alkenyl group, a hydroxy group, a formyl group, an acyl group, a carboxy group, an alkoxycarbonyl group, a carbamoyl group, and a sulfo group.

R²¹ is preferably a substituent substituting the carbon number 3, R²² is preferably a substituent substituting the carbon number 6 or 7, R²³ is preferably a substituent substituting the carbon number 11 or 12, and R²⁴ is preferably a substituent substituting the carbon number 17.

Y¹ and Y² are preferably hydrogen atoms or methyl groups.

a, b, c, and d are preferably integers of 0 to 2.

In a case in which the A ring is an unsaturated ring, the double bond is preferably bonded to the carbon numbers 4 and 5, in a case in which the B ring is an unsaturated ring, the double bond is preferably bonded to the carbon numbers 5 and 6 or 6 and 7, and, in a case in which the C ring is an unsaturated ring, the double bond is preferably bonded to the carbon numbers 8 and 9

Meanwhile, the compound represented by General Formula (2) includes any of stereoisomers. In a case in which the downward direction from the paper is represented by α and the upward direction from the paper is represented by β, the bonding direction of the substituent may be any one of α and β or a mixture thereof. In addition, the disposition of the A/B rings, the disposition of the B/C rings, and the disposition of the C/D rings may be any of a trans disposition and a cis disposition or a mixed disposition thereof.

In the present invention, it is preferable that the total of a to d is one or more and any of R²¹, R²², R²³, and R²⁴ is an alkyl group having a hydroxy group or a substituent.

The compound having a steroidal skeleton is preferably steroid as illustrated below.

In the following illustration, the substituent in the steroid ring is sterically controlled.

From the left side, cholestanes, cholanes, pregnanes, androstane, and estranes are illustrated.

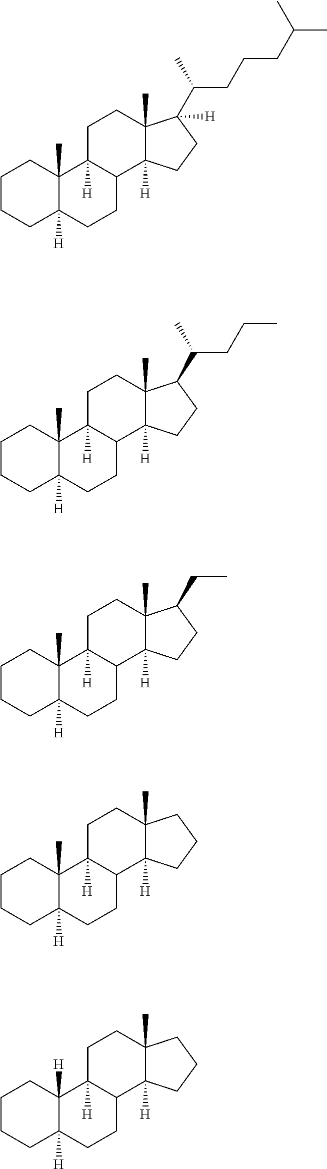

Specific examples of the aliphatic hydrocarbon represented by General Formula (2) include cholesterol, ergosterol, testosterone, estradiol, erdosterol, aldosterone, hydrocortisone, stigmasterol, timosterol, lanosterol, 7-dehydrodesostolol, 7-dehydrocholesterol, cholanic acid, cholic acid, lithocholic acid, deoxycholic acid, sodium deoxycholate, lithium deoxycholate, hyodeoxycholic acid, chenodeoxycholic acid, ursodeoxycholic acid, dehydrocholic acid, faucolic acid, and hyocholic acid. However, the present invention is not limited thereto.

As the aliphatic hydrocarbon represented by General Formula (2), it is possible to use a commercially available product.

Next, the compound including the structure in which at least one hydrogen atom in the aliphatic hydrocarbon represented by General Formula (2) is substituted with a bond will be described.

Hereinafter, the compound including the structure in which at least one hydrogen atom in the aliphatic hydrocarbon represented by General Formula (2) is substituted with a bond will be referred to as the compound including a partial structure represented by General Formula (2).

Compound derivatives (monomers) including the partial structure represented by General Formula (2) are preferably compounds derived by the esterification, etherification, or the like of a hydroxy group and the esterification, amidation, or the like of a carboxy group occurring in an alkyl group substituted with a reactive group such as a hydroxy group or a carboxy group among the substituents as R²¹, R²², R²³, and R²⁴.

In the present invention, the compound including the partial structure represented by General Formula (2) is preferably a polymer including an oligomer.

The partial structure represented by General Formula (2) may be included in any of the main chain or a side chain of the polymer and a polymer terminal; however, in the present invention, the partial structure is preferably included in the main chain or a side chain and more preferably included in a side chain.

In a case in which the compound including the partial structure represented by General Formula (2) is a polymer including an oligomer, in the compound including the partial structure represented by General Formula (2), at least one substituent of R²¹, R²², R²³, and R²⁴ is obtained from a polymerizable group or a compound (monomer) that is a group including a polymerizable group.

Here, the polymerizable group refers to a group that can be polymerized by a polymerization reaction, and examples thereof include groups that ring-opening-polymerize such as an ethylenic unsaturated group, an epoxy group, and an oxetanyl group, isocyanate groups that react with nucleophilic groups such as a hydroxyl group, an amino group, and a carboxy group.

Meanwhile, examples of the ethylenic unsaturated group include a (meth)acryloyl group, a (meth)acryloyloxy group, a (meth)acrylamide group, and a vinyl group (including an allyl group).

In the present invention, the polymerizable group is preferably an ethylenic unsaturated group, an epoxy group, or an oxetanyl group, more preferably a (meth)acryloyl group, a (meth)acryloyloxy group, a (meth)acrylamide group, a vinyl group, an epoxy group, or an oxetanyl group, still more preferably a (meth)acryloyl group, a (meth)acryloyloxy group, or an epoxy group, and particularly preferably a (meth)acryloyl group or a (meth)acryloyloxy group.

The group including the polymerizable group refers to a group to which the above-described polymerizable group is bonded through a linking group, and examples of the linking group include —O—, —S—, —SO₂—, —SO—, —C(═O)—, —N(R^{R1})—, an alkylene group, an alkenylene group, an arylene group, and groups obtained by combining the above-described linking groups. Here, R^{R1} represents a hydrogen atom, an alkyl group, or an aryl group.

Examples of the polymerizable group or the group including the polymerizable group as the substituent as R²¹, R²², R²³, and R²⁴ include —O—C(═O)—CH═CH₂, —O—C(═O)—C(CH₃)═CH₂, —C(═O)-alkylene-O—C(═O)—CH═CH₂, —C(═O)-alkylene-O—C(═O)—C(CH₃)═CH₂, —O—CH₂—CH═CH₂, —C(═O)-alkylene-O—CH₂—CH═CH₂, -alkylene-O—C(═O)—CH═CH₂, -alkylene-O—C(═O)—C(CH₃)═CH₂, O—CH₂-epoxy group, O—CH₂-oxetanyl group, —C(═O)-alkylene-O—CH₂-epoxy group, -alkylene-O—CH₂-epoxy group, and -alkylene-C(═O)—O—CH₂-epoxy group.

The polymerizable group or the group including the polymerizable group is preferably at least any one of the carbon numbers 3, 6, 7, 11, 12, and 17.

The polymer including the partial structure represented by General Formula (2) may be a homopolymer of the above-described compound or a copolymer; however, in the present invention, is preferably a copolymer.

In a case in which the polymerizable group is an ethylenic unsaturated group or a group including the ethylenic unsaturated group, examples of copolymerization components include (meth)acrylic acids, (meth)acrylic acid esters, (meth)acrylic acid amides, aromatic vinyl compounds (for example, styrene), ethylene, propylene, vinyl alcohol, esters of vinyl alcohol (for example, vinyl acetate), and the like.

In the present invention, compounds selected from (meth)acrylic acids, (meth)acrylic acid esters, and aromatic vinyl compounds are preferred.

In a case in which the polymerizable group is a group including an epoxy group, an oxetanyl group, an isocyanate group, or a group including the above-described group, examples thereof include alcohol compounds, amino alcohol compounds, amine compounds, carboxylic acid compounds, hydroxycarboxylic acid compounds, and the like.

The copolymerization components may be one kind or two or more kinds.

The compound including the partial structure represented by General Formula (2) preferably has a polar functional group (particularly, a hydroxy group, a carboxy group or a salt thereof, a sulfo group or a salt thereof, an amino group, or a cyano group).

The compound including the partial structure represented by General Formula (2) preferably has a long-chain alkyl group (having 8 to 30 carbon atoms) that can be dispersed in hydrocarbon-based solvents.

The compound more preferably contains the polar functional group and the long-chain alkyl group.

In the case of the polymer, copolymerized polymers having a repeating structure obtained from monomers having a polar functional group as a copolymerization component in addition to a repeating unit including the partial structure represented by General Formula (2) are preferred. In addition, copolymerized polymers having a repeating structure obtained from monomers having a long-chain alkyl group (having 8 to 30 carbon atoms) that can be dispersed in hydrocarbon-based solvents as a copolymerization component are also preferred. The polymer more preferably contains a repeating unit obtained from monomers having a polar functional group and a repeating unit obtained from monomers having a long-chain alkyl group.

The compound including the structure in which at least one hydrogen atom in the aliphatic hydrocarbon represented by General Formula (2) is substituted with a bond (the compound including the partial structure represented by General Formula (2)) can be synthesized using an ordinary method. For example, the compound can be synthesized in the following manner.

In commercially available products, hydroxy groups, amino groups, carboxy groups, sulfo groups, and the like which are directly bonded to steroid rings can be substituted with other substituents by means of an ordinary organic synthesis (for example, alkylation, arylation, acylation, or the like which is a nucleophilic substitution reaction).

The polymer including the partial structure represented by General Formula (2) can be obtained by synthesizing monomers including the partial structure represented by General Formula (2) and applying an ordinary polymerization method thereof.

For example, monomers including the partial structure represented by General Formula (2) which have a radical polymerizable unsaturated double bond are synthesized using the above-described method and are radical-polymerized in the presence of a radical polymerization initiator, whereby polymers having carbon chains in the main chain can be obtained.

Monomers including the partial structure represented by General Formula (2) which have a cationic polymerizable cyclic ether functional group (—O—) are synthesized using the above-described method and are cationic-polymerized in the presence of a cationic polymerization initiator, whereby polymers having ether groups in the main chain can be obtained.

Monomers including the partial structure represented by General Formula (2) which have a two or more-substituted hydroxy group, amino group, or carboxy group are condensation-polymerized in the presence of a condensation catalyst (for example, a bismuth catalyst or a tin catalyst), whereby condensable polymers such as polyester, polyamide, polyurethane, and polyimide can be obtained.

Specific examples of the compound having the partial structure represented by General Formula (2) will be illustrated below, but the present invention is not limited thereto.

Meanwhile, in the repeating unit of the polymer, x, y, and z have a unit of mol % and have an arbitrary numerical value of 1 to 100. The total is 100.

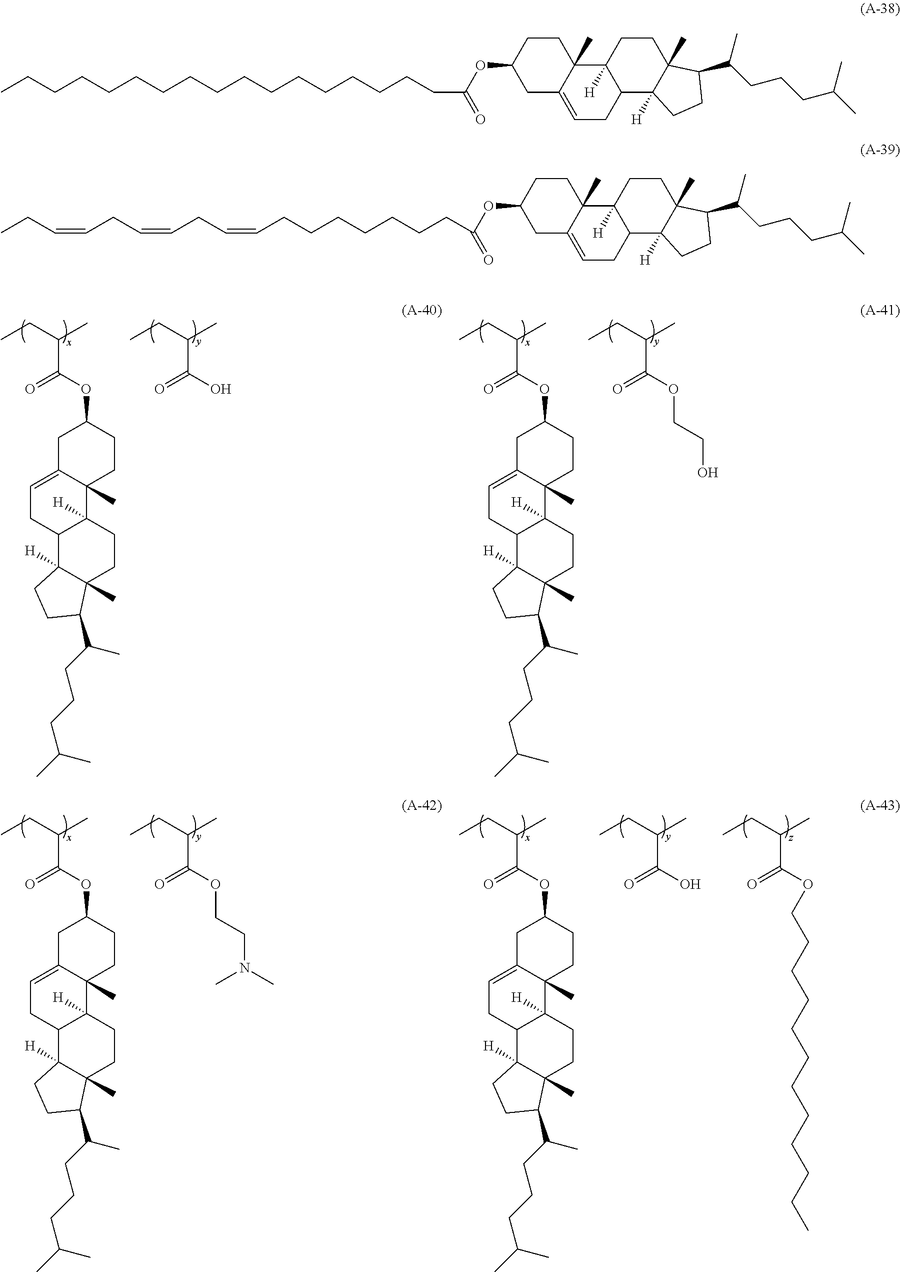

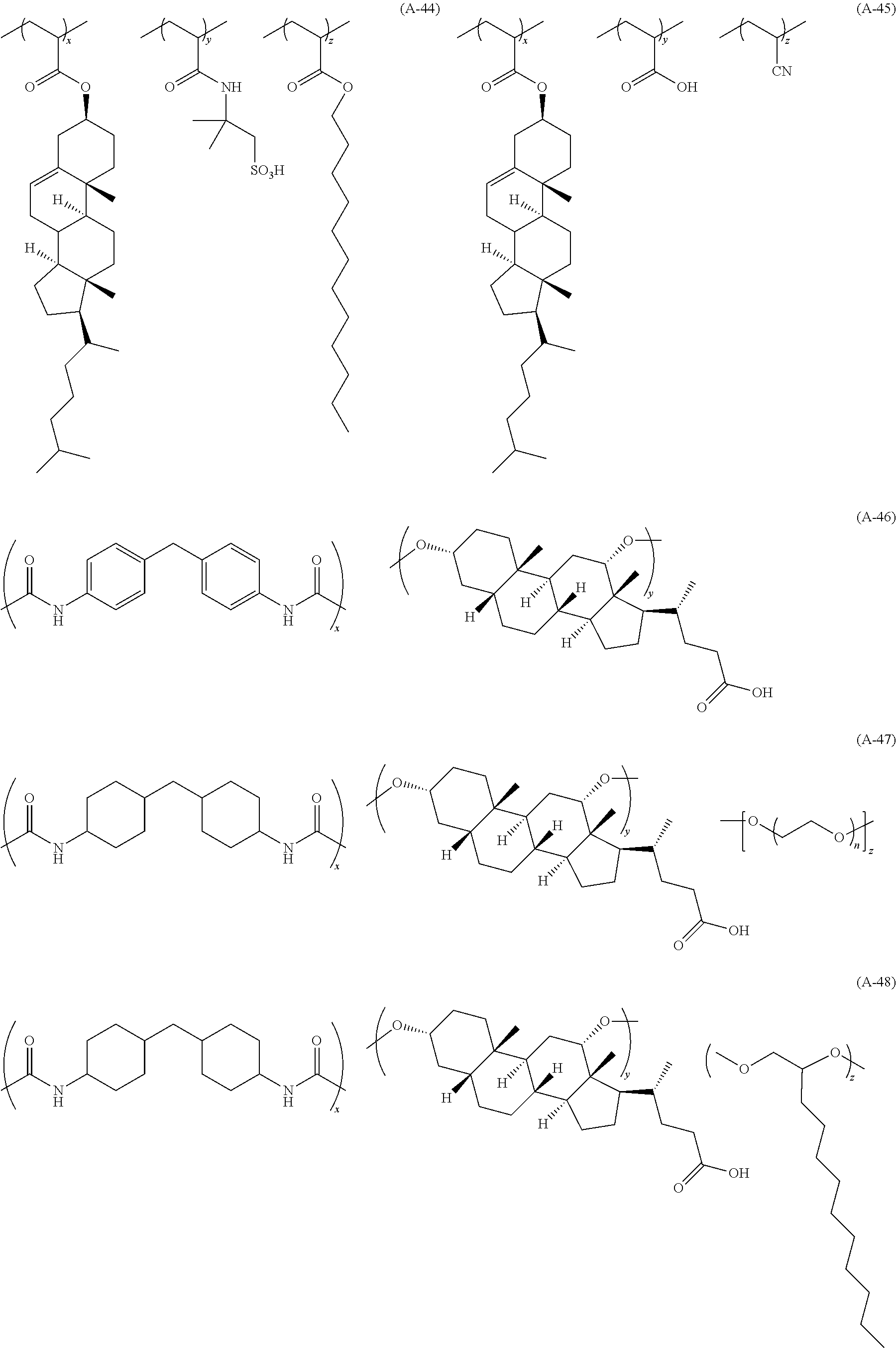

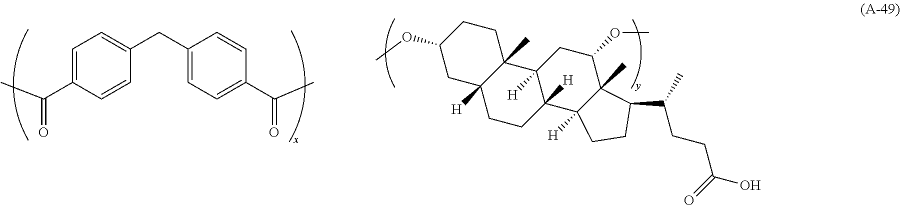

The content of the non-conductive compound having three or more rings which is used in the present invention is not particularly limited, but is preferably 0.1% to 20% by mass, more preferably 0.1% to 10% by mass, and still more preferably 0.1% to 5% by mass with respect to 100% by mass of the solid components of the material for a negative electrode.

(Dispersion Medium)

The material for a negative electrode of the present invention may also contain a dispersion medium that disperses the respective components described above. Specific examples of the dispersion medium include the following media.

Examples of alcohol compound solvents include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of ether compound solvents include alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, and the like), dimethyl ether, diethyl ether, diisopropyl ether, dibutyl ether, tetrahydrofuran, and dioxane.

Examples of amide compound solvents include N,N-dimethylformamide, 1-methyl-2-pyrrolidone, 2-pyrrolidinone, 1,3-dimethyl-2-imidazolidinone, ε-caprolactam, formamide, N-methylformamide, acetamide,N-methylacetamide, N,N-dimethylacetamide, N-methylpropanamide, hexamethylphosphoric triamide, and the like.

Examples of amino compound solvents include triethylamine, diisopropylethylamine, and tributylamine.

Examples of ketone compound solvents include acetone, methyl ethyl ketone, methyl isobutyl ketone, and cyclohexanone.

Examples of aromatic compound solvents include benzene, toluene, xylene, and the like.

Examples of aliphatic compound solvents include hexane, heptane, octane, decane, and the like.

Examples of nitrile compound solvents include acetonitrile, propionitrile, isobutyronitrile, and the like.

Examples of non-aqueous dispersion media include the aromatic compound solvents, the aliphatic compound solvents, and the like.

The content of the dispersion medium is preferably 10 to 95 parts by mass, more preferably 15 to 90 parts by mass, and particularly preferably 20 to 85 parts by mass in 100 parts by mass of the total mass of the material for a negative electrode.

The boiling point of the dispersion medium at normal pressure (one atmosphere) is preferably 50° C. or higher and more preferably 70° C. or higher. The upper limit is preferably 250° C. or lower and more preferably 220° C. or lower. The dispersion media may be used singly or two or more dispersion media may be used in combination.

In the present invention, among these, the aliphatic compound solvents are preferred, and heptane is more preferred.

Meanwhile, the viscosity of the material for a negative electrode is not particularly limited, but is preferably 100 to 2,000 mPa·s and more preferably 200 to 1,000 mPa·s in order to enable the uniform and efficient dispersion and coating of material for a negative electrode materials.

<<Solid Electrolyte Composition>>

Hereinafter, a solid electrolyte composition that is preferably applied as a material used to form the solid electrolyte layer and the positive electrode active material layer constituting the all-solid state secondary battery of the present invention (hereinafter, the solid electrolyte composition that is preferably applied as a material used to form the positive electrode active material layer will also be referred to as the material for a positive electrode”.).

The solid electrolyte composition preferably contains the inorganic solid electrolyte, the binder, and the dispersion medium. The solid electrolyte composition may contain a dispersant, the auxiliary conductive agent, and the lithium salt as necessary.

Meanwhile, in the case of being used as the material for a positive electrode for forming the positive electrode active material layer, the solid electrolyte composition contains the positive electrode active material.

(Positive Electrode Active Material)

The positive electrode active material is preferably a positive electrode active material capable of reversibly intercalating and deintercalating lithium ions. The above-described material is not particularly limited and may be transition metal oxides, elements capable of being complexed with Li such as sulfur, or the like. Among these, transition metal oxides are preferably used, and the transition metal oxides more preferably have one or more elements selected from Co, Ni, Fe, Mn, Cu, and V as transition metal. Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobaltate [LCO]), LiNi₂O₂ (lithium nickelate), LiNi_{0.85}CO_{0.10}Al_{0.05}O₂ (lithium nickel cobalt aluminum oxide [NCA]), LiNi_{0.33}CO_{0.33}Mn_{0.33}O₂ (lithium nickel manganese cobaltate [NMC]), and LiNi_{0.5}Mn_{0.5}O₂ (lithium manganese nickelate).

Specific examples of the transition metal oxides having a spinel-type structure (MB) include LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

The volume-average particle diameter (circle-equivalent average particle diameter) of the positive electrode active material that is used as the material for a positive electrode in the present invention is not particularly limited. Meanwhile, the volume-average particle diameter is preferably 0.1 μm to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. As the average particle diameter of positive electrode active material particles, the volume-average particle diameter (circle-equivalent average particle diameter) was measured using a laser diffraction/scattering-type particle size distribution measurement instrument LA-920 (trade name, manufactured by Horiba Ltd.).

The content of the positive electrode active material is not particularly limited, but is preferably 10% to 90% by mass and more preferably 20% to 80% by mass with respect to 100% by mass of the solid components in the material for a positive electrode.

The positive electrode active material may be used singly or two or more positive electrode active materials may be used in combination.

<Collector (Metal Foil)>

The collectors of positive electrodes and negative electrodes are preferably electron conductors. The collector of the positive electrode is preferably a collector obtained by treating the surface of an aluminum or stainless steel collector with carbon, nickel, titanium, or silver in addition to an aluminum collector, a stainless steel collector, a nickel collector, a titanium collector, or the like, and, among these, an aluminum collector and an aluminum alloy collector are more preferred. The collector of the negative electrode is preferably an aluminum collector, a copper collector, a stainless steel collector, a nickel collector, or a titanium collector and more preferably an aluminum collector, a copper collector, or a copper alloy collector.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 μm to 500 μm. In addition, the surface of the collector is preferably provided with protrusions and recesses by means of a surface treatment.

<Production of all-Solid State Secondary Battery>

The all-solid state secondary battery may be produced using an ordinary method. Specific examples thereof include a method in which the material for a negative electrode of the present invention or the solid electrolyte composition is applied onto a metal foil which serves as the collector, thereby producing an electrode sheet for an all-solid state secondary battery on which a coated film is formed.

For example, the material for a positive electrode is applied onto a metal foil which is a positive electrode collector so as to form a positive electrode active material layer, thereby producing a positive electrode sheet for an all-solid state secondary battery. The solid electrolyte composition for forming the solid electrolyte layer is applied onto the positive electrode active material layer, thereby forming a solid electrolyte layer. Furthermore, the material for a negative electrode is applied onto the solid electrolyte layer, thereby forming a negative electrode active material layer. A collector for the negative electrode (metal foil) is overlaid on the negative electrode active material layer, whereby it is possible to obtain a structure of an all-solid state secondary battery in which the solid electrolyte layer is sandwiched between the positive electrode active material layer and the negative electrode active material layer.

In the all-solid state secondary battery of the present invention, the electrode layers contain active materials. From the viewpoint of improving ion conductivity, the electrode layers preferably contain the inorganic solid electrolyte. In addition, from the viewpoint of improving the bonding properties between solid particles, between the electrodes, and between the electrodes and the collector, the electrode layers preferably contain the binder.

The solid electrolyte layer contains the inorganic solid electrolyte. From the viewpoint of improving the bonding properties between solid particles and between layers, the solid electrolyte layer also preferably contains the binder.

Meanwhile, the material for a negative electrode and the solid electrolyte composition may be applied using an ordinary method. At this time, the solid electrolyte composition for forming the positive electrode active material layer, the solid electrolyte composition for forming the inorganic solid electrolyte layer, and the material for a negative electrode may be dried after being applied respectively or may be dried after being applied into multiple layers. The drying temperature is not particularly limited. Meanwhile, the lower limit is preferably 30° C. or higher and more preferably 60° C. or higher, and the upper limit is preferably 300° C. or lower and more preferably 250° C. or lower. In a case in which the compositions are heated in the above-described temperature range, it is possible to remove the dispersion medium and form a solid state.

<Usages of all-Solid State Secondary Battery>

The all-solid state secondary battery according to the present invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles, electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

Among these, the all-solid state secondary battery is preferably applied to applications for which a high capacity and high-rate discharging characteristics are required. For example, in electricity storage facilities in which an increase in the capacity is expected in the future, it is necessary to satisfy both high reliability, which is essential, and furthermore, the battery performance. In addition, in electric vehicles mounting high-capacity secondary batteries and domestic usages in which batteries are charged out every day, better reliability is required against overcharging. According to the present invention, it is possible to preferably cope with the above-described use aspects and exhibit excellent effects.

According to the preferred embodiment of the present invention, individual application forms as described below are derived.

(1) Materials for a negative electrode containing a binder.

(2) Electrode sheets for an all-solid state secondary battery produced by applying the material for a negative electrode onto a metal foil and forming a negative electrode active material layer.

(3) Electrode sheets for an all-solid state secondary battery produced by applying a material for a positive electrode onto a metal foil so as to form a positive electrode active material layer, applying a solid electrolyte composition onto the positive electrode active material layer so as to form a solid electrolyte layer, and applying the material for a negative electrode on the solid electrolyte layer so as to form a negative electrode active material layer.

(4) Methods for manufacturing an electrode sheet for an all-solid state secondary battery, in which the material for a negative electrode is applied onto a metal foil, and a film is formed.

(5) Methods for manufacturing an all-solid state secondary battery in which a negative electrode active material layer is produced by applying a slurry in which a sulfide-based inorganic solid electrolyte is dispersion using a non-aqueous dispersion medium in a wet manner.

Meanwhile, examples of the methods for the material for a negative electrode or the solid electrolyte composition onto a metal foil include coating (wet-type coating), spray coating, spin coating, dip coating, slit coating, stripe coating, and bar coating.

All-solid state secondary batteries refer to secondary batteries having a positive electrode, a negative electrode, and an electrolyte which are all constituted of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the Li—P—S, LLT, LLZ, or the like is used. Meanwhile, the application of high-molecular-weight compounds to inorganic all-solid state secondary batteries is not inhibited, and high-molecular-weight compounds can also be applied as binders of positive electrode active materials, negative electrode active materials, and inorganic solid electrolyte particles.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include the Li—P—S, LLT, and LLZ. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, when differentiated from electrolytes as the ion transportation materials, the materials are referred to as “electrolyte salts” or “supporting electrolytes”. Examples of the electrolyte salts include lithium bis-trifluoromethanesulfonimide (LiTFSI).

In the present invention, “materials for a negative electrode” or “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto. In the following examples, “parts” and “%” are mass-based unless particularly otherwise described.

<Synthesis of Sulfide-Based Inorganic Solid Electrolyte>

—Synthesis of Li—P—S-Based Glass—

As a sulfide-based inorganic solid electrolyte, Li—P—S-based glass was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, injected into an agate mortar, and mixed using an agate muddler for five minutes. Meanwhile, the mixing ratio between Li₂S and P₂S₅ was set to 75:25 in terms of molar ratio.

66 zirconia beads having a diameter of 5 mm were injected into a 45 mL zirconia container (manufactured by Fritsch Japan Co., Ltd.), then, the full amount of the mixture of the lithium sulfide and the diphosphorus pentasulfide was injected thereinto, and the container was sealed in an argon atmosphere. The container was set in a planetary ball mill P-7 (trade name, manufactured by Fritsch Japan Co., Ltd.), mechanical milling was carried out at a temperature of 25° C. and a rotation speed of 510 rpm for 20 hours, thereby obtaining yellow powder (6.20 g) of Li—P—S-based glass (sulfide-based inorganic solid electrolyte).

<Preparation of Dispersant>

2,2′-Azobis(2,4-dimethylvaleronitrile) (4 parts by mass) and heptane (230 parts by mass) were injected into a flask including a cooling pipe. After that, styrene (4 parts by mass), methacrylic acid (12 parts by mass), cholestanol methacrylate (10 parts by mass), 2-methylglycidyl methacrylate (28 parts by mass), 2-hydroxyethyl methacrylate (24 parts by mass), and benzyl methacrylate (16 parts by mass) were injected thereinto, and the reaction system was substituted with nitrogen. The components began to be stirred gently using a stirrer, the temperature of the solution was increased to 70° C., and the components were stirred for four hours while maintaining the temperature, thereby obtaining a polymer solution. The concentration of the solid content of the obtained polymer solution was 30.0% by mass, and the mass average molecular weight of the polymer (steroid-based macromolecule) was 30,000.

### Example 1

—Preparation of Solid Electrolyte Composition—

180 zirconia beads having a diameter of 5 mm were injected into a 45 mL zirconia container (manufactured by Fritsch Japan Co., Ltd.), and the Li—P—S-based glass synthesized above (9.5 g), polyvinylidene fluoride-hexafluoropropylene copolymer (PVdF-HFP) (0.5 g), and 1,4-dioxane (15.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 300 rpm for two hours, thereby preparing α solid electrolyte composition.

—Preparation of Composition for Positive Electrode of all-Solid State Secondary Battery (Material for Positive Electrode)—

180 zirconia beads having a diameter of 5 mm were injected into a 45 mL zirconia container (manufactured by Fritsch Japan Co., Ltd.), and the Li—P—S-based glass synthesized above (0.5 g), polyvinylidene fluoride-hexafluoropropylene copolymer (PVdF-HFP) (0.5 g), and 1,4-dioxane (12.3 g) as a dispersion medium were injected thereinto. The container was set in a planetary ball mill P-7 (trade name) manufactured by Fritsch Japan Co., Ltd., and the components were continuously mixed at a temperature of 25° C. and a rotation speed of 300 rpm for two hours. After that, lithium cobaltate (LCO, manufactured by Nippon Chemical Industrial Co., Ltd.) (9.0 g) was injected as an active material into the container, again, the container was set in the planetary ball mill P-7, and the components were continuously mixed at a temperature of 25° C. and a rotation speed of 100 rpm for 15 minutes. A material for a positive electrode was prepared in the above-described manner.

—Preparation of Composition for Negative Electrode of all-Solid State Secondary Battery (Material for Negative Electrode)—

(1) Preparation of Material for Negative Electrode (S-1)

180 zirconia beads having a diameter of 5 mm were injected into a 45 mL zirconia container (manufactured by Fritsch Japan Co., Ltd.), and graphite (spherical graphite powder, in Table 1, expressed as “Graphite”) (8 parts by mass), a dispersant (pyrene) shown in Table 1 (0.1 parts by mass), the Li—P—S-based glass synthesized above (2 parts by mass), a binder (HSBR, hydrogenated styrene-butadiene rubber, manufactured by JSR Corporation, trade name: DYNARON 1321P) (0.3 parts by mass), and heptane (10 parts by mass) as a dispersion medium were injected thereinto. The container was set in a planetary ball mill P-7 (trade name) manufactured by Fritsch Japan Co., Ltd., and the components were continuously dispersed mechanically at a temperature of 25° C. and a rotation speed of 360 rpm for 90 minutes, thereby preparing α material for a negative electrode (S-1). Meanwhile, the mass average molecular weight of the HSBR, measured by means of GPC, was 200,000, and Tg was −50° C.

(2) Preparation of Materials for Negative Electrode (S-2) to (S-5) and (HS-1)

Materials for a negative electrode (S-2) to (S-5) and (HS-1) were prepared in the same manner as the material for a negative electrode (S-1) except for the fact that, in the preparation of the material for a negative electrode (S-1), the composition was changed as shown in Table 1. Meanwhile, the materials for a negative electrode (S-1) to (S-5) are the material for a negative electrode which becomes an example, and the material for a negative electrode (HS-1) is a comparative material for a negative electrode.

<Measurement Method>

—Method for Measuring Concentration of Solid Content—

10 g of the prepared polymer solution was weighed on an aluminum cup, was dried on a hot plate at 170° C. for six hours, and then the mass excluding the mass of the aluminum cup was measured. The proportion of the mass excluding the mass of the aluminum cup in 10 g of the original weight was considered as the concentration of the solid content.

—Measurement of Molecular Weight—

As the mass average molecular weights of the dispersant and the binder which are used in the present invention, the mass average molecular weights converted to standard polystyrene by means of gel permeation chromatography (GPC) were employed. The measurement instrument and the measurement conditions are described below.

Column: a column produced by connecting TOSOH TSKgel Super HZM-H,
TOSOH TSKgel Super HZ4000, and
TOSOH TSKgel Super HZ2000 (all are trade names, manufactured by Tosoh Corporation) was used.

Carrier: Tetrahydrofuran

Measurement temperature: 40° C.

Carrier flow rate: 1.0 ml/min

Specimen concentration: 0.1% by mass

Detector: RI (refractive index) detector

—Viscosity—

The viscosity was measured using the material for a negative electrode (50 mL) and a B-type viscometer BL2 (trade name) manufactured by Tokyo Keiki Inc. The temperature of the material for a negative electrode had been maintained at the measurement temperature in advance until the temperature became constant, and the measurement was initiated after that. The measurement temperature was set to 25° C.

—Glass Transition Temperature (Tg)—

Tg was measured using a dried specimen and a differential scanning calorimeter “X-DSC7000” (trade name, SII•NanoTechnology Inc.) under the following conditions. The glass transition temperature of the same specimen was measured twice, and the measurement result of the second measurement was employed.

Atmosphere in the measurement chamber: nitrogen (50 mL/min)

Temperature-increase rate: 5° C./min

Measurement-start temperature: −100° C.

Measurement-end temperature: 200° C.

Specimen pan: aluminum pan

Mass of the measurement specimen: 5 mg

Estimation of Tg: Tg is estimated by rounding off the middle temperature between the declination-start point and the declination-end point in the DSC chart to the integer.

The dispersion stability of the materials for a negative electrode (S-1) to (S-5) and (HS-1) prepared above was evaluated.

<Dispersion Stability Test>

The materials for a negative electrode prepared above were put into a stoppered test pipe having an external diameter of 18 mm and a length of 180 mm and were left to stand at 25° C. for 24 hours. After the elapsing of 24 hours, the materials were visually observed and evaluated using the following evaluation standards. The results are shown in Table 1. Rankings B or higher are passing levels.

—Evaluation Standards—

After the elapsing of 24 hours, syneresis occurred: C

After the elapsing of 24 hours, no changes were observed: B

Even after the elapsing of 48 hours, no changes were observed: A

TABLE 1

| Material for | | Parts | | Parts | Inorganic | Parts | | Parts | | Parts | Viscosity | |
|---|---|---|---|---|---|---|---|---|---|---|---|---|
| negative | Active | by | | by | solid | by | | by | Dispersion | by | (25° C.) | Dispersion |
| electrode | material | mass | Dispersant | mass | electrolyte | mass | Binder | mass | medium | mass | (mPa · s) | stability |
| S-1 | Graphite | 8 | Pyrene | 0.1 | Li—P—S | 2 | HSBR | 0.3 | Heptane | 10 | 640 | B |
| S-2 | Graphite | 8 | Deoxycholic | 0.1 | Li—P—S | 2 | HSBR | 0.3 | Heptane | 10 | 620 | B |
| | | | acid | | | | | | | | | |
| S-3 | Graphite | 8 | Deoxycholic | 0.1 | Li—P—S | 2 | — | — | Heptane | 10 | 780 | A |
| | | | acid | 0.3 | | | | | | | | |
| | | | Steroid-based | | | | | | | | | |
| | | | macromolecule | | | | | | | | | |
| S-4 | Graphite | 8 | Steroid-based | 0.3 | Li—P—S | 2 | — | — | Heptane | 10 | 680 | A |
| | | | macromolecule | | | | | | | | | |
| S-5 | Graphite | 8 | Steroid-based | 0.3 | LLT | 2 | — | — | Heptane | 10 | 740 | A |
| | | | macromolecule | | | | | | | | | |
| HS-1 | Graphite | 8 | — | — | Li—P—S | 2 | HSBR | 0.3 | Heptane | 10 | 640 | C |

<Notes of Table 1>
Li—P—S: Li—P—S-based glass synthesized above
LLT: Li_{0.33}La_{0.55}TiO₃ (average particle diameter: 3.25 μm, manufactured by Toshima Manufacturing Co., Ltd.)
Steroid-based macromolecule: steroid-based macromolecule synthesized above

As is clear from Table 1, it is found that the materials for a negative electrode of the present invention (S-1) to (S-5) were excellent in terms of dispersion stability. In contrast, the material for a negative electrode (HS-1) not containing the dispersant that is used in the present invention was poor in terms of dispersion stability.

Production of Negative Electrode Sheet for all-Solid State Secondary Battery

The material for a negative electrode prepared above was applied onto a 20 μm-thick aluminum foil using an applicator having an adjustable clearance, was heated at 80° C. for one hour, and then was further heated at 110° C. for one hour, thereby drying the dispersion medium. After that, the material was heated and pressurized (at 10 MPa for 10 seconds) using a heat pressing machine, thereby producing a negative electrode active material layer.

The solid electrolyte composition prepared above was applied onto the negative electrode active material layer produced above using an applicator having an adjustable clearance, was heated at 80° C. for one hour, and then was further heated at 110° C. for six hours. A sheet having a solid electrolyte layer formed on the negative electrode active material layer was heated and pressurized (at 10 MPa for 10 seconds) using a heat pressing machine, thereby producing a negative electrode sheet for an all-solid state secondary battery.

Production of Positive Electrode Sheet for all-Solid State Secondary Battery

The material for a positive electrode prepared above was applied onto a 20 μm-thick aluminum foil using an applicator having an adjustable clearance, was heated at 80° C. for one hour, and then was further heated at 110° C. for one hour, thereby drying the dispersion medium. After that, the material was heated and pressurized (at 10 MPa for 10 seconds) using a heat pressing machine, thereby producing a positive electrode sheet for an all-solid state secondary battery.

Manufacturing of all-Solid State Secondary Battery

An all-solid state secondary battery illustrated in FIG. 2 was produced.

A disc-shaped piece having a diameter of 14.5 mm was cut out from the negative electrode sheet for an all-solid state secondary battery manufactured above and was put into a 2032-type stainless steel coin case 11 into which a spacer and a washer were combined so that the surface of a disc-shaped piece having a diameter of 13.0 mm cut out from the positive electrode sheet for an all-solid state secondary battery which was coated with the material for a positive electrode and the solid electrolyte layer faced each other, thereby manufacturing all-solid state secondary batteries (coin batteries) 13 of Test Nos. 101 to 105 and c11 shown in Table 2.

An electrode sheet for an all-solid state secondary battery 12 had the constitution of FIG. 1. The positive electrode active material layer, the solid electrolyte layer, and the negative electrode active material layer respectively had the film thicknesses shown in Table 2.

On the all-solid state secondary batteries of Test Nos. 101 to 105 and c11 manufactured above, the following tests were carried out. The results are summarized in Table 2.

<Cycle Characteristics>

The cycle characteristics of the all-solid state secondary battery were measured using a charging and discharging evaluation device “TOSCAT-3000 (trade name)” manufactured by Toyo System Co., Ltd.

The all-solid state secondary battery was charged at a current density of 2 A/m² until the battery voltage reached 4.2 V, and, once the battery voltage reached 4.2 V, the all-solid state secondary battery was charged with constant voltage until the current density reached less than 0.2 A/m². The all-solid state secondary battery was discharged at a current density of 2 A/m² until the battery voltage reached 3.0 V. The above-described process was considered as one cycle, the discharge capacity in the third cycle was considered as 100, all-solid state secondary batteries for which the number of cycles was less than 30 when the discharge capacity reached less than 80 were evaluated as C (Fail), all-solid state secondary batteries for which the number of cycles was 30 or more were evaluated as B (Pass), and all-solid state secondary batteries for which the number of cycles was 50 or more were evaluated as A (Pass).

<Occurrence of Peeling in Interface Between Negative Electrode Active Material and Solid Electrolyte>

After the cycle characteristic test, the all-solid state secondary battery was removed from the coin case, was cut in a lamination direction using a razor blade, and the cross-section of the negative electrode active material layer was observed using a tabletop microscope “TM-1000” (trade name, manufactured by High-Technologies Corporation) at an enlargement factor of 3,000 times.

All-solid state secondary batteries in which peeling occurred in the interface between the graphite and the solid electrolyte were evaluated as C (Fail), and all-solid state secondary batteries in which peeling did not occur were evaluated as B (Pass). Furthermore, all solid secondary batteries in which the symptom of peeling was not observed even at an enlargement factor of 5,000 times were evaluated as being particularly favorable, A (Pass).

TABLE 2

| | | | Solid | | | | | |
|---|---|---|---|---|---|---|---|---|
| | Positive electrode active | | electrolyte | Negative electrode active | | | | |
| | material layer | | layer | material layer | | | | |
| | Basis | Film | Film | | Basis | Film | Test results | |
| Test | weight | thickness | thickness | | weight | thickness | Cycle | Occurrence |
| No. | (mg/cm²) | (μm) | (μm) | Kind | (mg/cm²) | (μm) | characteristics | of peeling |
| 101 | 12.4 | 60 | 45 | S-1 | 8 | 60 | B | B |
| 102 | 12.4 | 60 | 45 | S-2 | 8 | 60 | B | B |
| 103 | 12.4 | 60 | 45 | S-3 | 8 | 60 | A | A |
| 104 | 12.4 | 60 | 45 | S-4 | 8 | 60 | A | A |
| 105 | 12.4 | 60 | 45 | S-5 | 8 | 60 | A | A |
| c11 | 12.4 | 60 | 45 | HS-1 | 8 | 60 | C | C |

<Notes of Table 2>
“Kind” indicates which material for a negative electrode prepared above was used.
“Basis weight” indicates the mass (mg) of the active material per unit area (cm²) of the active material layer.

As is clear from Table 2, the all-solid state secondary batteries of Test Nos. 101 to 105 which were produced using the material for a negative electrode of the present invention exhibited favorable cycle characteristics. From the fact that peeling did not occur in the interface between the negative electrode active material and the solid electrolyte, it is considered that, in the negative electrode active material layers of the all-solid state secondary batteries produced using the material for a negative electrode of the present invention, favorable interfaces were formed between solid particles. In contrast, the all-solid state secondary battery of Test No. c11 which failed to satisfy the regulations of the present invention was poor in terms of cycle characteristics.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: coin case
12: electrode sheet for all-solid state secondary battery
13: coin battery

What is claimed is:

1. A material for a negative electrode comprising:
a carbonaceous material that is a negative electrode active material;
an inorganic solid electrolyte; and
a non-conductive compound having a ring structure with three or more rings.

2. The material for a negative electrode according to claim 1,
wherein the non-conductive compound having a ring structure with three or more rings is a compound represented by General Formula (D) or a compound including a structure in which at least one hydrogen atom in the compound is substituted with a bond, 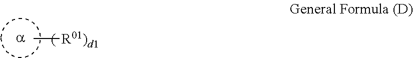
in General Formula (D), ring α represents a ring with three or more rings, R^{D1} represents a substituent bonded to a constituent atom of the ring α, d1 represents an integer of 1 or more, in a case in which d1 is 2 or more, a plurality of R^{D1}'s may be identical to or different from each other, and R^{D1}'s substituting atoms adjacent to each other may be bonded to each other and thus form a ring.

3. The material for a negative electrode according to claim 2,
wherein the compound represented by General Formula (D) is at least one compound selected from the group consisting of an aromatic hydrocarbon represented by General Formula (1), an aliphatic hydrocarbon represented by General Formula (2), and a compound having a structure in which at least one hydrogen atom in the aromatic hydrocarbon or the aliphatic hydrocarbon is substituted with bonds, 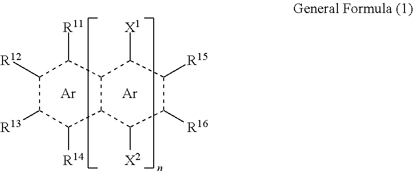
in General Formula (1), Ar represents a benzene ring, n represents an integer of 0 to 8, R¹¹ to R¹⁶ each independently represent a hydrogen atom or a substituent, X¹ and X² each independently represent a hydrogen atom or a substituent, here, in R¹¹ to R¹⁶ and X¹ and X², groups adjacent to each other may be bonded to each other and thus form a five or six-membered ring, here, in a case in which n is zero, any one substituent of R¹¹ to R¹³ is -(Ar¹)m-Rx or any two of R¹¹ to R¹³ are bonded to each other and thus form -(Ar¹)m-, here, Ar¹ represents a phenylene group, m represents an integer of 2 or more, and Rx represents a hydrogen atom or a substituent, and, in a case in which n is one, in R¹¹ to R¹⁶ and X¹ and X², at least two atoms or substituents adjacent to each other are bonded to each other and thus form a benzene ring, 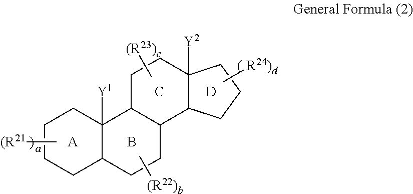
in General Formula (2), Y¹ and Y² each independently represent a hydrogen atom, a methyl group, or a formyl group, R²¹, R²², R²³, and R²⁴ each independently represent a substituent, and a, b, c, and d represent integers of 0 to 4,
here, A ring may be a saturated ring, an unsaturated ring or aromatic ring having one or two double bonds, and B ring and C ring may be an unsaturated ring having one or two double bonds, and, in a case in which the integer as each of a, b, c, and d is 2 to 4, substituents adjacent to each other may be bonded to each other and thus form a ring.

4. The material for a negative electrode according to claim 1, further comprising:
a binder.

5. The material for a negative electrode according to claim 1,
wherein the carbonaceous material that is a negative electrode active material is hard carbon or graphite.

6. The material for a negative electrode according to claim 1,
wherein the inorganic solid electrolyte is a sulfide-based inorganic solid electrolyte.

7. An electrode sheet for an all-solid state secondary battery produced by applying the material for a negative electrode according to claim 1 onto a metal foil.

8. An all-solid state secondary battery comprising:
a positive electrode active material layer;
a negative electrode active material layer; and
an inorganic solid electrolyte layer,
wherein the negative electrode active material layer is produced by applying the material for a negative electrode according to claim 1 to form a layer.

9. A method for manufacturing an electrode sheet for an all-solid state secondary battery produced by applying the material for a negative electrode according to claim 1 onto a metal foil.

10. A method for manufacturing an all-solid state secondary battery, the method comprising:
manufacturing an all-solid state secondary battery through the manufacturing method according to claim 9.
